(19) United States
(12) Patent Application Publication
(10) Pub. No.: US 2016/0117650 A1
(43) Pub. Date: Apr. 28, 2016

(54) PAYMENT SYSTEM

(71) Applicant: Karmic Labs, Inc., San Francisco, CA (US)

(72) Inventors: Ryan Weidenmiller, San Francisco, CA (US); Chris Agerton, San Francisco, CA (US)

(21) Appl. No.: 14/657,883

(22) Filed: Mar. 13, 2015

Related U.S. Application Data
(63) Continuation-in-part of application No. 14/524,746, filed on Oct. 27, 2014.
(60) Provisional application No. 62/098,579, filed on Dec. 31, 2014.

(51) Int. Cl. G06Q 20/10; G06Q 20/34; G06Q 20/26; G06Q 20/00

(52) U.S. Cl. CPC G06Q 20/10; G06Q 20/00; G06Q 20/34; G06Q 20/26

(57) ABSTRACT

The payment system disclosed herein provides for receiving a request from a first user for funds from an account related to an organization, determining an organizational level of the user in the organization, determining the fund access privilege of the first user based on the organizational level of the user; and associating a set of fund use privileges for the first user, the set of fund use privileges including an amount of funds available to the user, a type of transactions allowed using the funds and a time period for use of the funds.

### CROSS-REFERENCE TO RELATED APPLICATIONS

This application is a continuation-in-part application of and claims benefit of U.S. Non-Provisional application Ser. No. 14/524,746 entitled “PAYMENT SYSTEM” and filed Oct. 27, 2014, and claims benefit of U.S. Provisional Application Ser. No. 62/098,579 entitled “PAYMENT SYSTEM” and filed on Dec. 31, 2014, both of the '746 application and the '579 application are incorporated herein by reference in their entirety.

### FIELD

Implementations disclosed herein relate, in general, to information management technology and specifically to payment systems.

### SUMMARY

The payment system disclosed herein provides for receiving a request from a first user for funds from an account related to an organization, determining an organizational level of the user in the organization, determining the fund access privilege of the first user based on the organizational level of the user; and associating a set of fund use privileges for the first user, the set of fund use privileges including an amount of funds available to the user, a type of transactions allowed using the funds and a time period for use of the funds.

An alternative implementation of the payment system disclosed herein also provides for receiving requests from a first user for funds from an account related to a consumer, determining the need for the consumer, determining the fund access privilege of the consumer based on the request, and then associating a set of fund use privileges for the first user. Yet alternative implementation of the payment system may also be used for consumer applications where an individual can establish groups (for example a family, a social group, a sports team, etc.) with a primary account and subsequent account holders tied to the primary account.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example block diagram representing a payment system disclosed herein.

FIG. 2 illustrates an alternative example block diagram representing a payment system disclosed herein.

FIG. 3 illustrates an example graphical user interface used to collect organizational information using the payment system disclosed herein.

FIG. 4 illustrates an example graphical user interface used to add employees and contractor information using the payment system disclosed herein.

FIG. 5 illustrates an example graphical user interface used to create a vault to manage expenses using the payment system disclosed herein.

FIG. 6 illustrates an example graphical user interface used by an employee or a contractor to enroll into the payment system.

FIG. 7 illustrates an example graphical user interface displaying the transaction size and expense limits for various cardholders.

FIG. 8 illustrates an example graphical user interface displaying organizational budget and current levels of spending for an organization.

FIG. 9 illustrates an example graphical user interface displaying summaries for various cardholders' expense accounts.

FIG. 10 illustrates an example graphical user interface, displaying summary for an individual cardholder's expense account.

FIG. 11 illustrates an example graphical user interface that allows setting fund limits for a specific time period for a number of cardholders.

FIG. 12 illustrates an example graphical user interface that allows creating an event and setting fund limits for a number of cardholders related to the event.

FIG. 13 illustrates an example graphical user interface that allows changing cards while maintaining recurring transactions.

FIG. 14 illustrates an example graphical user interface that provides portfolio analytics and activity monitoring.

FIG. 15 illustrates a flowchart illustrating operations for setting up an organization on the payment system disclosed herein.

FIG. 16 illustrates a flowchart illustrating operations for creating groups within the organization, adding group members, and associating cardholders with groups.

FIG. 17 illustrates an example graphical user interface that allows creating and managing groups within an organization using the payment system.

FIG. 18 illustrates a flowchart illustrating operations for creating funds and setting funds for the event using the payment system.

FIG. 19 illustrates a flowchart illustrating operations for determining usage of cards with changed numbers or expiration dates for recurring transactions.

FIG. 20 illustrates an example computing system that can be used to implement the payment system disclosed herein.

FIG. 21 illustrates an example mobile device that may be used to implement one or more parts of the payment system disclosed herein.

FIG. 22 illustrates an example graphical user interface that allows pushing time-based funds to a user.

FIG. 23 illustrates an example graphical user interface that allows reducing time-based funds available to a user.

FIG. 24 illustrates a flowchart illustrating operations for ensuring that a predetermined amount of funds are always available to a user.

### DETAILED DESCRIPTION

Developed economies around the world are characterized by large organizations involving a very large number, some times up to various thousands, of members. For example, according to rough estimates, on average a Fortune 500 company in the US employs approximately 52,000 employees. Various employees of such organizations may incur expenses on behalf of the organization. Generally, such expenses are managed by requiring the employees to keep track of their expenses and submit periodic expense reports, either in paper form or online. Typically, each entry in such expense reports require various detailed information, such as the date of the expense, amount of expense, the type of expense, the country (domestic or international) of the expense, the expense account related to the expense, etc. Entering such information is time consuming for the employee and likely to generate various errors as found by corporate finance. Furthermore, it requires frequent auditing, review, comparison to allocated expense budgets, etc. All of these steps lead to inefficiencies for organizational shareholders and employee dissatisfaction.

Furthermore, the employees at these large organizations are divided into a number of departments, groups, etc., and each of such department, group, is given a periodic budget. For example, a company may have departments for marketing, research, administration, sales, etc. Furthermore, each of such departments may be further required to track their expenses based on product lines, geography, etc. Expensive human and technological systems are used to ensure that the expenses get properly allocated to the proper department, product lines, etc., get audited, meet the budgetary expectations, etc. Most of the current processes are not real time in that budgets are set on a periodic basis, the information is communicated to the members of the group, the members provide expense reports on periodic basis, and the expense reports for a given period are reviewed and compared against the budgets usually much after the period is over.

Currently, if a business entity (LLP, LLC, Corporation, Sole Proprietorship, or Association/Organization) is interested in distributing purchasing cards to its employees or contractors for purchasing, the entity would typically have to do so while give its employees access to corporate credit via credit cards, or make such employees co-signers to the bank account for a business debit card. In addition to the below features of the claims, this application also creates a technical system to allow a business entity to give cards to all of its employees and contractors, without granting those individuals access to corporate credit funds or making them co-signers to the bank account. These solutions allow such entities to give cards to all employees in an organization, with dynamic controls and management of budget-linked expenses. The system also uses a proprietary approach to calculating, for business entities or parents, an optimal funding mechanism based on the number of cards and estimated spend amount the cards. Alternatively, the funding mechanism may be based on other parameters such as number of cards, daily balances, and monthly allowance, as well as funding capabilities. Such funding may also be dependent on a user organization as to whether the organization is cash rich, cash poor, heavily depending on credit, etc. For example, if the organization is cash poor, more frequent funding schedule may be adopted, compared to an organization that is cash rich and would like to reduce the number of funding transactions and related bookkeeping and transaction expense.

The payment system disclosed herein provides a rule-based engine for managing expenses for organizations using cards issued to members of the organization. An implementation of the payment system disclosed herein allows an organization to issue purchasing, per diem or expense card (referred to herein generally as the “card”) to all, or as many as necessary, employees and contractors (referred to herein generally as the “cardholder”). The administrator of the payment system (referred to herein generally as the “administrator”) at the organization can set individual limits on expenses by each cardholder. For example, the administrator can set periodic limits, geographic limits, etc., on the expenses for a cardholder. As an example, an employee Bob Smith working in the marketing department can be issued a card with an expense limit of $1,000 per month.

While in some instance, each cardholder is issued a physical card that can be used at point of sales (POS) system that use card swiping or scanning technology to complete transactions, in alternative implementations, the cardholder may be issued only an electronic card that can be used with a mobile device such as a smartphone to complete transactions. In yet alternative implementations, both a physical card and an electronic card that work together are issued to the cardholders. Furthermore, the payment system disclosed herein is also contemplated to include other modalities of payment that combine location of the cardholder together with other cardholder identifying characteristics to complete transactions.

Furthermore, the administrator can group a number of cardholders into one or more departments and set expense limits per department as necessary. Thus, an administrator can set total expense limit for combined expenses of all cardholders in the marketing department to $10,000 per month. Furthermore, the payment system also allows delegation of setting the limits down to department heads. Thus, the administrator can leave it up to the head of the marketing group to decide how to allocate the budgeted $10,000 for the entire department among the marketing department cardholders.

The payment system also allows department heads and/or the cardholders to request additional budget in real-time. Thus, for example, a cardholder may have a monthly budgeted allocation of $500 and if they require additional $200 of expenses for a given month, the cardholder may use one of the graphical user interfaces provided by the payment system to request the additional funds. In response to such a request, the payment system automatically sends a message (in the form of text message, a message within a mobile application, an email, etc.) to an administrator or to a department head of the additionally requested funds. The administrator or the department head may again use a GUI to approve the request, approve the request partially, deny the request, etc. If for example the administrator approves the request for the additional $200, the payment system automatically sends a notification to the cardholder and the additional funds are shown in their available budget. At the same time, the system also sends a message to the appropriate funding source to inform of the additional budget so that the funding source makes the additional funds available to the cardholder. Furthermore, the budgets for the department and for the organization are also dynamically updated in real time to reflect the additional expense allowance. The payment system also allows the administrators to set up automatic approval of some amount of additional budget for selected or all cardholders. For example, the administrator can setup the system such that each cardholder request of additional budget of $100 or less per a given period is automatically approved. Alternatively, a percentage based automatic approval, an employee status based automatic approval, etc., can be selected.

The present application also discloses a mobile application that links to various issued cards such that the mobile application manages various functionalities and user interactions. For example, the mobile application may be used to display availability of funds to the cardholders, display current use of funds compared to the budget in a graphical format, allow users to request additional funds using the mobile application, etc. In one implementation of the payment system, the mobile application also allows the cardholder to use the mobile application itself as a payment tool. For example, the payment system mobile application may generate a graphical payment bar code (such as a QR code) that can be scanned by merchants to complete transactions.

Furthermore, the payment system also allows creating events, allocating budgets for the events, associating departments and cardholders to the event, etc. Thus, for example, if a company is planning a conference for a two days in New York, where it is planning to launch a new product, the administrator can create a new event for the conference and associate all departments and cardholders that will be involved in hosting, managing, and/or attending the product launch event. Furthermore, the administrator can create a total budget for the expenses related to the product launch event and allocate budgeted expenses to those associated cardholders. Furthermore, payment system also allows the administrators to silo the expenses related to the event aside from total budgeted expense for the cardholder (at the discretion of the administrator or the department head). Thus, for example, if the conference is in on May 19^{th} and 20th and if Bob Smith, who is participating in the conference, has an initial budget of $1,000 approved for the month of May, an additional conference related budget of $250 for the conference would not affect the monthly budget (resulting in total allowed expenses of $1,250).

Yet alternatively, the payment system allows the administrators and department heads to voluntarily push funds to the cardholders. For example, due to increased budget for the department the department head may push notification about additional funds available to the cardholders. As another example, if a department is allocated a budget of $5,000 per month and on the last day of the month it is determined that some of the funds are still unused, a department head may push funds to one of the cardholders that may have an opportunity and/or need to use such unused funds. On the converse, the administrators or the department heads can also curtail or reduce the budget in response to unexpected events.

The payment system disclosed includes a reporting module configured to generate a number of interactive graphical user interfaces for generating and displaying various expense reports. For example, such reports allows the administrator to review current level of spending by each of the cardholder, remaining amount that can be still used by the cardholder for a given period, etc. Other reports display organizational level and department level actual expenditures compared to the budgeted expenditures in real time. The reporting module also allows the administrators and department heads to review the details of each and every expense incurred by the cardholders. Yet alternatively, the reporting module also provides graphical views of the dates of the expenses, the location of the expense, etc. The reporting module of the payment system may be available on mobile devices such as smartphones, tablets, etc., as well as via web based dashboards that can be accesses by mobile devices, laptops, desktops, etc.

The payment system disclosed herein also allows making predictions about future cash requirements for the organization based on the budgets for the cardholders, the group, and the organization, the past behavior of the expenses incurred by the cardholder, the upcoming events, the upcoming recurring transactions, etc. Subsequently, funding rules and schedule may be set up to fund the cards based on the predictions. For example, if an upcoming event set up by the administrator is going to require $1,500 in additional expenditure and a given future date, the payment system can automatically request a funding of the purchasing cards to account for such upcoming expense just in time before the event time period.

The payment system disclosed herein is integrated at the back end to one or more debit and credit card service providers such that the payment system receives level 3 enhanced data from the service provider. Level 3 data is a network (Visa, Mastercard) certified process allowing for enhanced transactional data reported separately to the aggregated transaction amount including sales tax, freight amount, duty amount, and line item details (product or service ID, product or service description, quantity, item amount, and unit of measure). The payment system processes the level 3 enhanced data to automatically generate reports and to update accounting and financial systems in a dynamic manner. For example, the level 3 enhanced data allows identifying taxes paid on various transactions by the cardholders, thus simplifying the accounting for the transactions. Furthermore, the level 3 enhanced data provides additional detail about the transaction, such as the type of purchased items (food, entertainment, IT equipment, clothing, medicine, etc.). Additionally, information about the merchant, the location, the time, etc., related to the transaction is also provided.

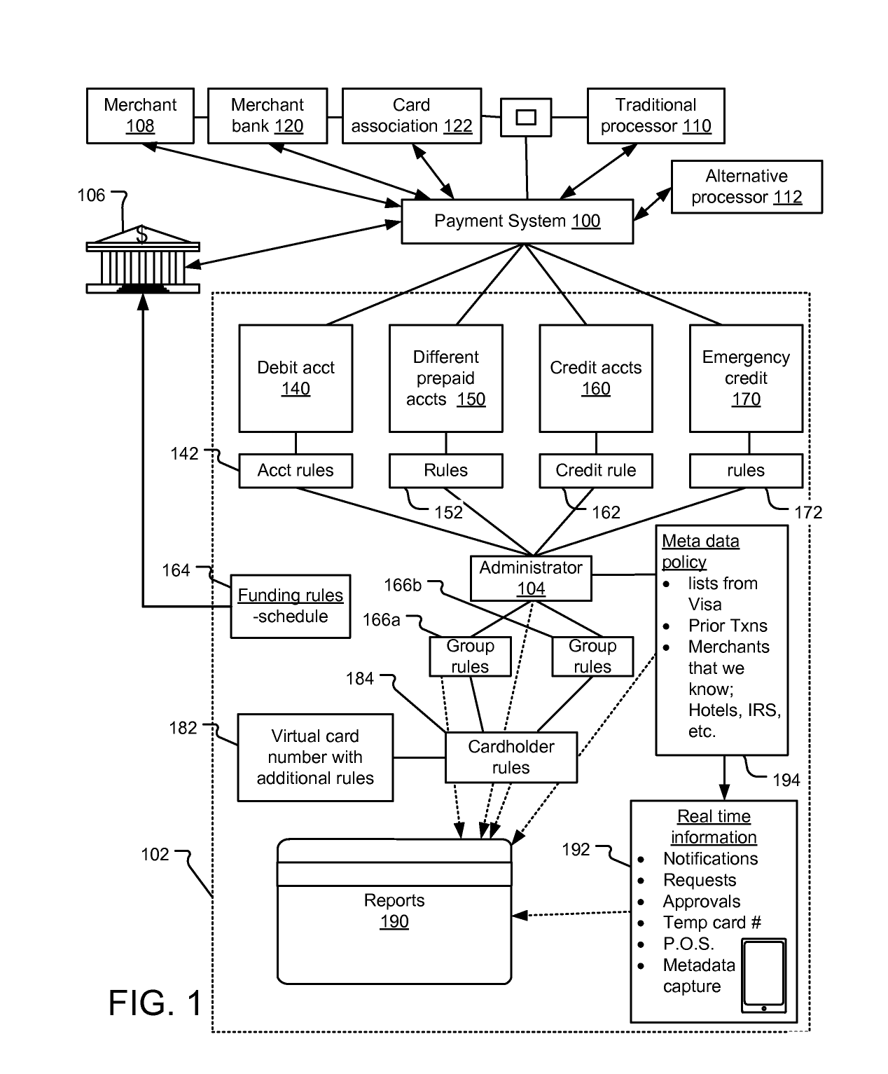

One or more of the functionalities and operations of the payment system disclosed herein are disclosed below in more detail with respect to FIGS. 1-20 below.

FIG. 1 illustrates an example block diagram representing a payment system 100 disclosed herein. Various modules of the payment system may be implemented on one or more computing systems. For example, one or more of the modules may be implemented on a cloud-based system, wherein various user devices can access the payment system over the Internet, over wireless networks, etc. The payment system 100 is illustrated as working with an organization 102. For example, the organization 102 may be a Fortune 500 company having a large number of employees and contractors, working in one or more of a large number of organizations.

In an alternative implementation, the organization may be a family, a social group, a sports team, etc. For example, a recreational sports league may us the payment system 100 for one or more if its members. Alternatively, a family may use the payment system 100 so that the members of the family are cardholders and a head of the family may be the administrator of the payment system 100. Thus, the terms “organization,” “administrator,” “cardholder,” etc., are to be interpreted to include such applications where the payment system 100 is used for non-organizational groups of users.

The use of the payment system 100 by the organization 102 may be managed by an administrator 104, such as the controller of the organization 102, the CFO of the organization 102, etc. The administrator 104 may be a single person, a group of persons, a department, a smart engine that makes decisions based on a set of predetermined rules, etc. In the illustrated implementation, the organization 102 is shown as using the payment system 100 using one funding source 106. However, in alternative implementation, more than one funding sources may be used. The funding source 106, such as a bank, a credit union, etc., funds various purchasing cards used by the organization 102. In one implementation, the payment system 100 coordinates the interactions between the funding source 106 and one or more credit/debit card processors 110, 112. For example, the card processor 110 may be a traditional credit card processor such as Flagship Merchant™, Merchant Warehouse™, etc., of alternative processors such as Paypal™, etc.

The payment system 100 also interacts with merchants 108 directly to receive various out of band metadata, such as location of the merchant 108, type of merchandise used, etc. When a cardholder of the organization uses a purchasing card issued using the payment system 100 at the merchant 108, a merchant bank 120 (also known as the acquiring bank, such as First Data™, Square™, FIS™, etc.), which is a member of a card association 122 (such as Visa™, Mastercard™, etc.), receives information about the transaction and deposits funds to the merchant 108.

The payment system 100 provides the administrator 104 a number of capabilities for managing funding on the cards for various cardholders. For example, the administrator 104 may set up a number of different types of accounts for funding the cards. Example account types are debit accounts 140, prepaid accounts 150, credit accounts 160, emergency credit accounts 170, etc. Furthermore, the administrator 104 can associate different rules for each of these different accounts. For example, for debit accounts 140, there may be debit account rules 142 specifying the daily total amount of transactions that a cardholder can complete. The debit account rules 142 may also specify to the funding source 106 how often to fund the debit account 140.

Similarly, the administrator 104 may also assign different accounting rules 152 to be used with prepaid accounts 150. As an example, such prepaid accounts 150 may be associated with various geographic limitations as to where the funds from the prepaid accounts 150 may be spent, time limits as to during what time period the funds from the prepaid accounts 150 are to be allowed, expense type limitations, etc. In a similar manner it is also contemplated to associate credit rules 162 to the credit accounts 160 and other rules to the emergency credit account 170.

The payment system 100 also allows the administrator 104 to set a number of funding rules 164 that are used by the funding source 106. An example of such a funding rule 164 may be funding a debit account 140 whenever the balance in the debit account falls below a predetermined amount. Another such funding rule 164 may be to increase limit on a credit account 160 as a percentage of the monthly total budget for the organization 102. Furthermore, the funding rules 164 also provides a schedule for funding the accounts 140, 150, 160, 170, etc.

Furthermore, the administrator 104 also sets up one or more group rules 166a, 166b, where each group rule 166 provides rules for a group of cardholders. For example, the group rule 166a may control the expense rules for a group of cardholders that are working in marketing department. An example of such a rule is to associate expenses generated from the transactions by this group of cardholders with marketing expense. Another example rule may be to limit each individual transaction to less than a predetermined amount per day, where such predetermined amount is the expected maximum transaction amount for a marketing department employee. Note that the above are just a few example rules and other rules controlling the type of expenses, the daily maximum amount, etc., may be also provided.

The administrator 104 may also define various cardholder rules 184, where each cardholder rule 184 controls transactions by a given cardholder. An example cardholder rule may be to limit the number of transactions that a cardholder can enter into per day, an amount of food related expenses that a cardholder can enter into in any given day, etc. The cardholder rules 184 may also specify geographic limitations on the card. Thus, in one example, a cardholder may be limited to transactions within ten miles of a given destination where the cardholder is visiting. Such cardholder level rules allows for controlling fraud by the cardholder as well as preventing misuse of the card by the cardholder or by a third party, if the card is lost or stolen, thus decreasing the organization's exposure.

The cardholder rules 184 may also be associated with a virtual card number 182 and additional rules for such virtual card number. Such virtual credit card numbers may be provided to a cardholder for one time transaction or a group of selected transactions. For example, when a cardholder is traveling out of country where there may be risk of card number being stolen, the cardholder may request from the administrator 104 such virtual card number. The rules associated with the virtual card number may be more stringent so as to limit the risk to the organization.

The payment system 100 is configured to generate a number of reports 190 (further discussed in detail in the following figures). For example, a report 190 may be a top-level report for the organization that provides real-time summary of the expenses incurred by the cardholders compared to the total budget. Another report 190 may be used by individual heads of departments in the organization 102 where each department report 190 provides expenses incurred by each cardholder in that department, the total budget for the department compared to the total expenses incurred to date, etc.

The payment system 100 also generates various real-time information 192 including real-time notifications, requests, approvals, etc. For example, if a cardholder is at a merchant POS and needs real-time increase in available funds, the cardholder may be able to generate a text message to the administrator 104 to request such additional funds in real-time. Similarly, the administrator 104 may be able to generate real-time approvals, where such approvals automatically increase available funds for the cardholder as well as generate simultaneous text message, email, application message, etc., to the cardholder to notify that the request for additional funds has been approved. The real-time information 192 may also include metadata captures by the payment system 100 at the POS. Alternatively, a cardholder may request a temporary of virtual card, where the virtual card number is sent to the cardholder in real-time via text, email, etc., as well as to a mobile device based payment system application, such that the cardholder may use the new virtual card to complete transaction using the mobile device based payment system application.

The payment system 100 also provides a metadata policy 194 that can be set and modified by the administrator 104. Thus, the administrator 104 can specify the type of metadata that is collected from processors 110, 112. For example, such metadata may include list of transaction from a processor, information from merchants such as hotels, IRS, etc., that may be able to provide more detailed metadata related to transactions, etc.

Various components of the payment system 100 may be implemented on a network of computing devices where some computing devices may be dedicated servers, other computing devices may be cloud based server, etc. Furthermore, one or more components of the payments system 100 may be implemented as a mobile device application, a web-based application, a dedicated computer based application, etc. For example, a cardholder may use a mobile device based application to view one or more reports 190 related to that cardholders budget, list of recent transactions entered into by that cardholder, etc. Furthermore, such mobile device based application can also be used to generate a bar code that is scanned by POS terminals to complete transactions for the cardholders.

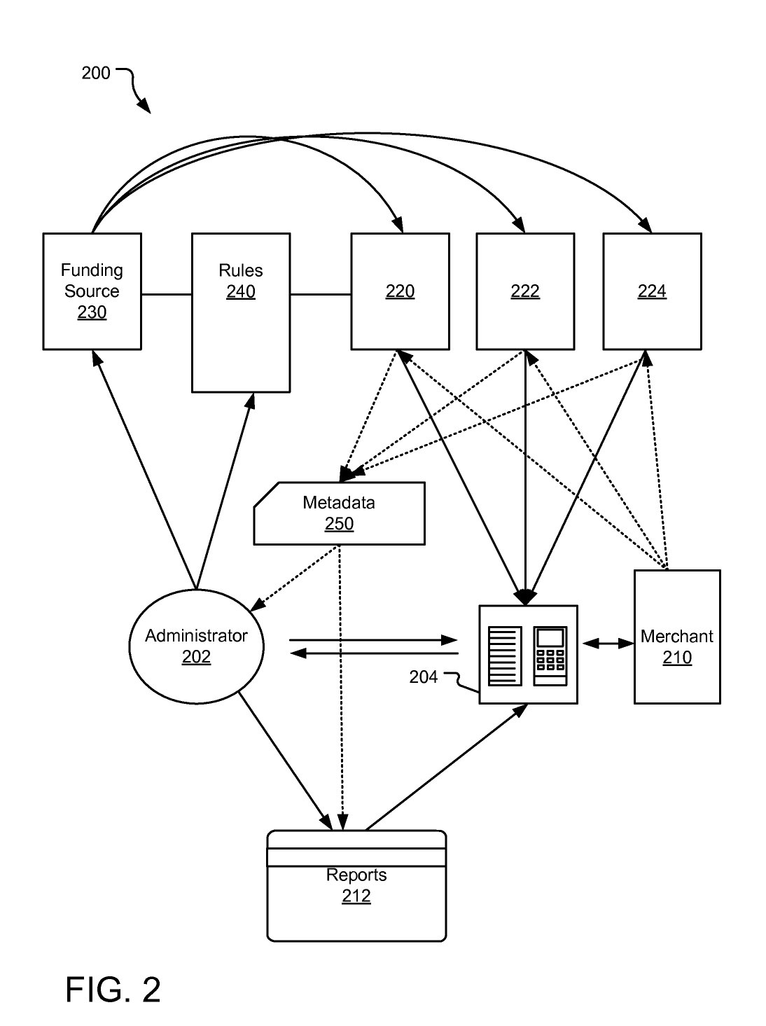

FIG. 2 illustrates an alternative example block diagram representing a payment system 200 disclosed herein. Specifically, the payment system 200 illustrates the interaction of an administrator 202 for an organization and a cardholder 204 with various other participants of the payment system 200. The administrator 202 may be a person, such as a CFO, controller, etc., or a department that is in charge of maintaining the payment system 200 for various cardholders (employees, contractors, etc.) within the organization, including the cardholder 204. The cardholder 204 is illustrated here via a mobile device, however, in an alternative implementation, the cardholder 204 may participate in or use the payment system 200 using a physical credit card, a virtual credit card number, etc. For example, the cardholder 204 may be able to use a card issued as part of the payment system using a web terminal to complete transactions.

The administrator 202 communicates with a funding source 230 and sets up various rules, including funding rules to be used by the funding source, various rules to be used by card processors 220, 222, 224, etc. The payment system 200 allows the administrator 202 and the cardholder 204 to communicate directly with each other as well as indirectly through various reports 212 generated by the payment system 202. For example, the cardholder 204 may send a request to the administrator 202 for additional funds, for change in the budget, etc. Similarly, the administrator 202 may communicate with the cardholder 204 with instructions on use of cards, restrictions, changes, approvals, etc.

The cardholder 204 may use cards at one or more merchants 210 through POS, mobile applications, websites, etc. For example, the cardholder 204 may use the card at a website of the merchant where the merchant 210 sells airline tickets. Alternatively, the same merchant may be selling the airline tickets via a mobile device application downloaded by the cardholder 204 on its mobile device. The merchant 210 works with one of the card processors 220, 222, 224, etc. For example, such processors 220, 222, 224 may be traditional card processors or alternative card processors such as Paypal™, etc. The card processors 220, 222, 224 may provide various metadata 250 for various transactions to the administrator. For example, the card processors generate level 3 metadata. Such metadata 250 is used by the payment system 200 to generate various reports 212 that may be used by the administrator 202, the cardholder 204, etc.

In an alternative implementation, the payment system 100 may also be configured to determine preferred vendors based on the information received from the POS 210. For example, if a transaction request is received from a preferred coffee provider, such as Starbucks™, the payment system 200 may identify it as a preferred vendor, in which case, the payment is not directly processed at the time of the transaction. For example, the payment system 200 may have a contractual arrangement with Starbucks, wherein all cards associated with the payment system 200 are processed pursuant to a special relation between the payment system 200 and Starbucks. Thus, the payment system 200 avoids the individual transaction costs associated with each individual transactions by payment system's cardholders. In one implementation, such preferred vendor sends periodic payment requests based on the transactions for that period. Furthermore, the preferred vendor may give special discount to the cardholders of the payment system 200.

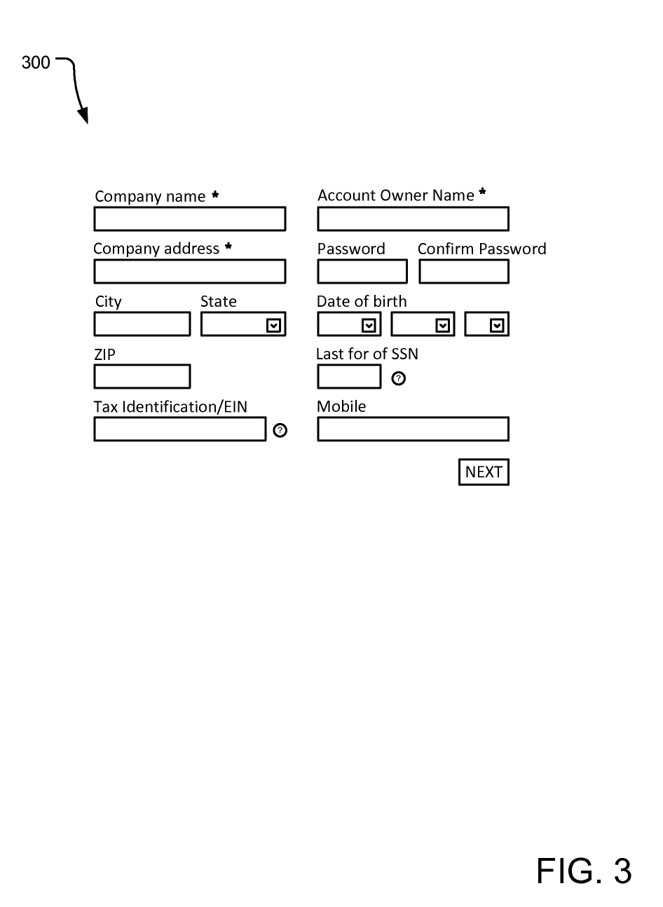

FIG. 3 illustrates an example graphical user interface 300 used to collect organizational information using the payment system disclosed herein. An administrator may use the GUI 300 to input information about the company, contact information about the administrator, and security passwords. In addition, an implementation of the payment system utilizes a combination of algorithmic logic and optical character recognition to validate that the collected data is accurate and pertinent to the business entity itself. Specifically, the validation process maintains authentication of business entity type (Sole Proprietorship, Limited Liability Corporation, Corporation, Partnership (General, LPs, LLPs, LLLPs), and Organization or Association (non-profit). For example, The validation may be a five step automatic process involving the administrator uploading specific business entity artifacts and the payment system proceeding to (1) authenticate business entity type, (2) verify business entity address, (3) verify business entity Employer Identification Number (EIN), (4) upload and recognize and store associated business entity artifacts corresponding to enrollment information, (5) score all information for pass or failure (if pass then the account is subsequently opened, if failure, the account is not opened). This process enables business entities to be approved via an on-line application process that covers customer identification process (CIP), know your client (KYC), bank secrecy act (BSA), anti-money laundering (AML), and office of foreign asset control (OFAC) measures mandated to open a financial instrument.

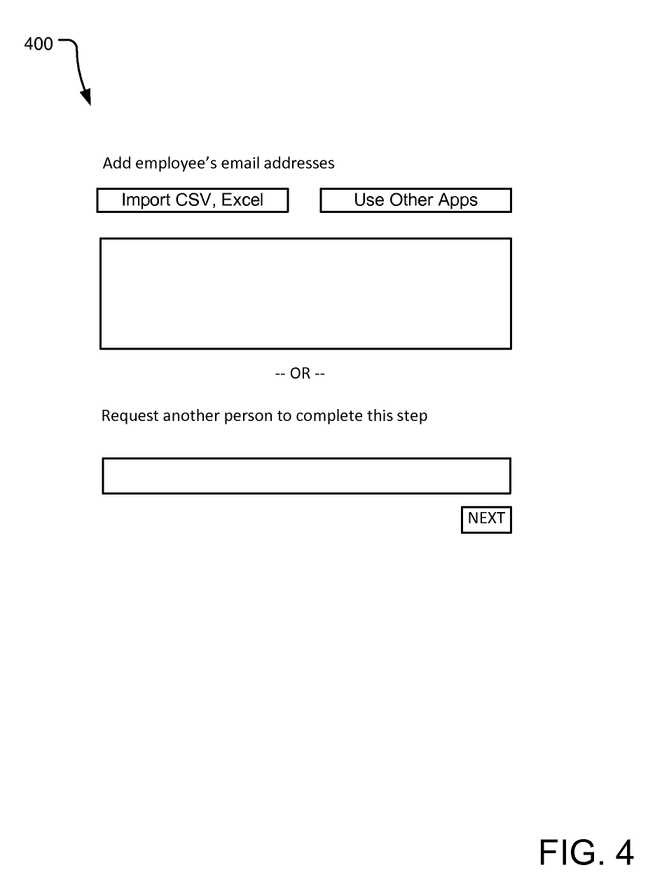

FIG. 4 illustrates an example graphical user interface 400 used to add cardholders' information using the payment system disclosed herein. The administrator can add the cardholders' information by uploading a csv file, an Excel file, etc. Such file containing cardholder information may include the email addresses of the cardholders for the company, phone numbers, names, etc. Alternatively, the administrator can input information of the cardholders in an input window. Yet alternatively, the administrator can delegate the task of providing cardholder information to a third party, such as for example, to an assistant, etc., by providing the email of such third party. In such a case, the payment system sends an email to such third party together with a link to a GUI that can be used to add the cardholder information.

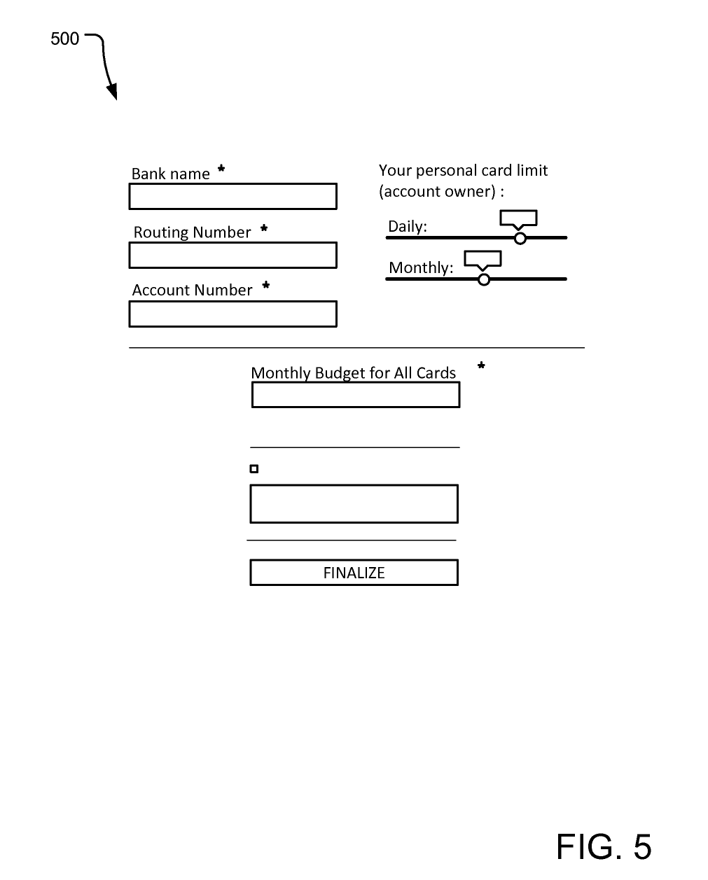

FIG. 5 illustrates an example graphical user interface 500 used to create a vault to manage expenses using the payment system disclosed herein. The administrator can provide information about a funding source, such as an operating account, etc., of the organization. While in the example implementation, only one funding source is attached to an organization, in alternative implementation, more than one funding sources may be tied to an organization.

Once the payment system receives the cardholder information, the payment system sends a message to all the cardholders that they are invited to enroll in the payment system. Such message may be sent by an email, text message, an application message, etc. The cardholders can select the option to enroll in the payment system by clicking on a link provided in the message or going to a particular website and putting in the required information provided in the message.

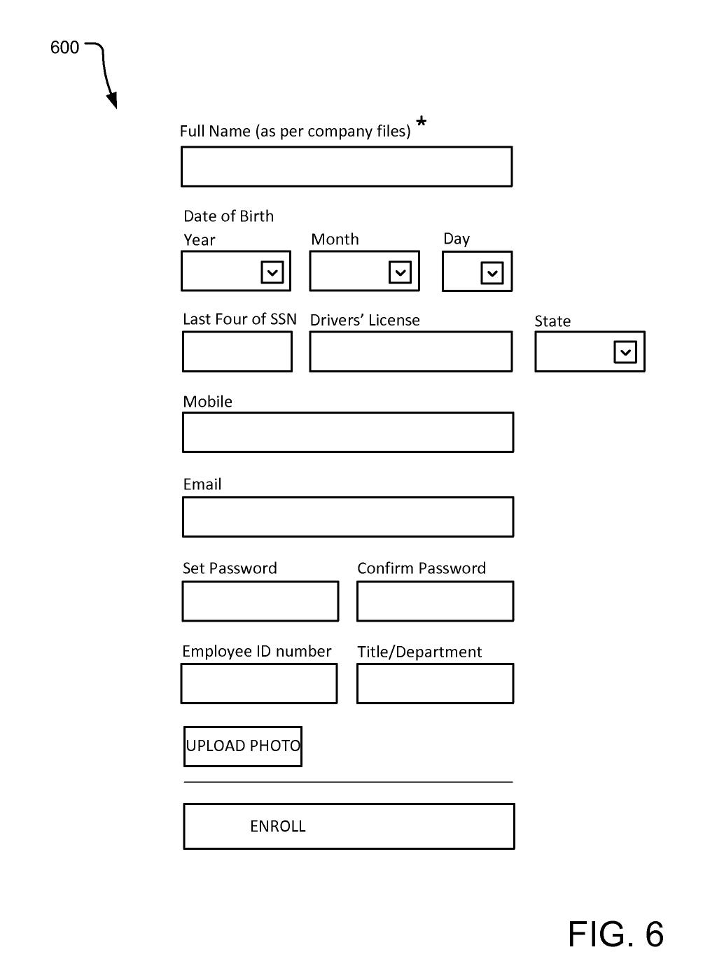

FIG. 6 illustrates an example graphical user interface 600 that may be presented to the cardholder to enroll into the payment system. The cardholder provides various identifying information that can be used by the payment system to verify or identify the cardholder. Furthermore, the information provided by the GUI 600 is also used by the payment system to assign the cardholder to a particular department, geographic group, etc. Thus, for example, once the cardholder provides an employee id number, the payment system may use the employee id number to associate the cardholder to a department and subsequently associate the budgeted expenses for the cardholder and the incurred expenses for the cardholder to that particular department.

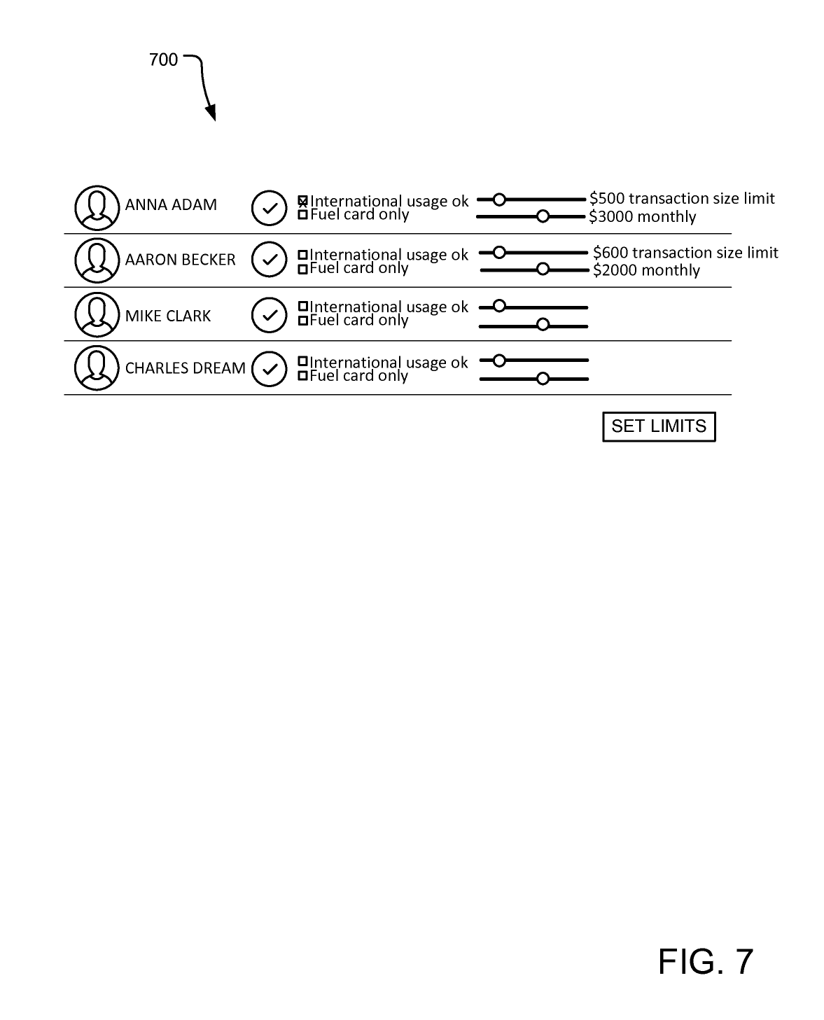

FIG. 7 illustrates an example graphical user interface 700 displaying the transaction size and expense limits for various cardholders. The GUI 700 is a convenient dashboard tool that can be used by an administrator of the payment system to set various limits on the use of a card by a cardholder. For example, in the given illustration, the administrator may give Anna Adam the permission to use the card for international transactions. Furthermore, the administrator can also drag the button shows in the GUI to set transaction limit and monthly expense limit for each cardholder.

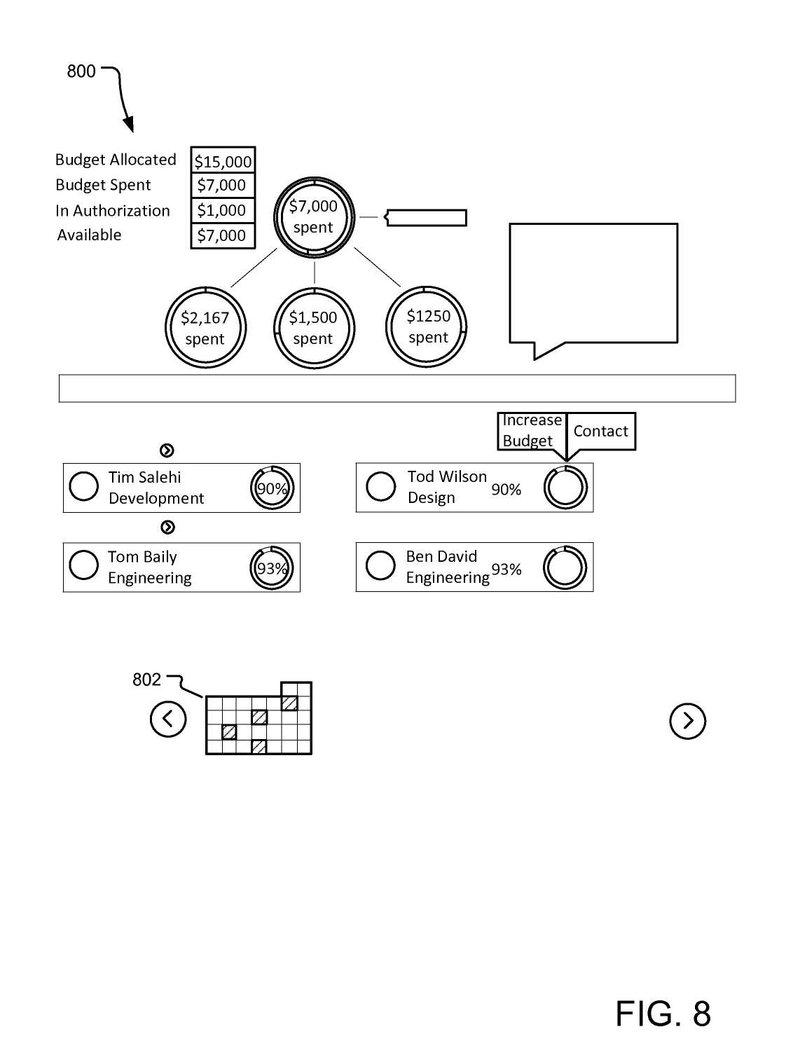

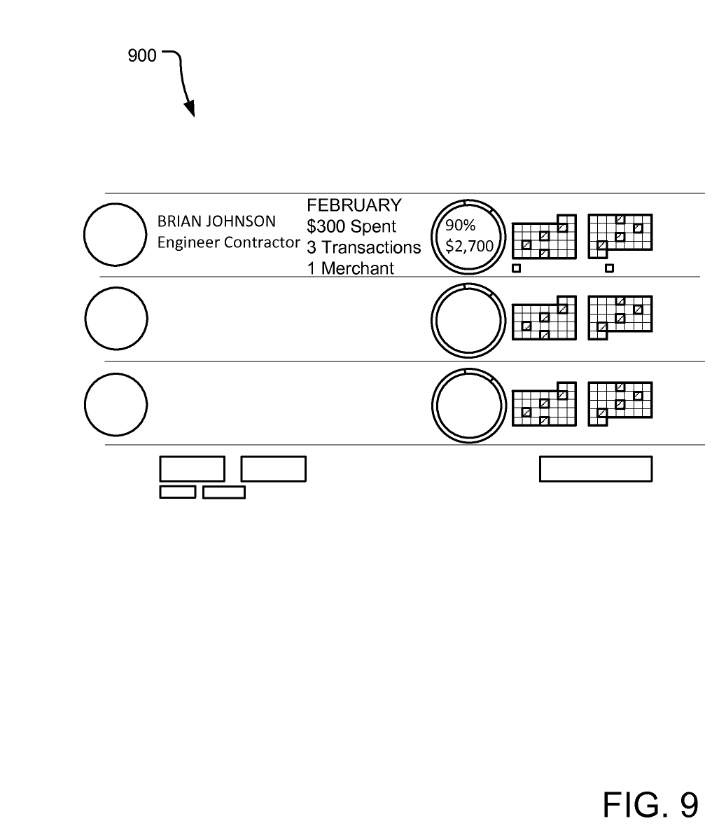

FIG. 8 illustrates an example graphical user interface 800 displaying organizational budget and current levels of spending for an organization. The administrator can view at a very high level the organization level budgets compared to the actuals, department level budgets compared to the actuals, etc. Furthermore, a calendar view 802 also allows the administrator to view the dates of the expenses for a selected cardholder, department, etc. On the other hand, FIG. 9 illustrates an example graphical user interface 900 displaying summaries for various cardholders' expense accounts using similar GUI elements as compared to the GUI 800.

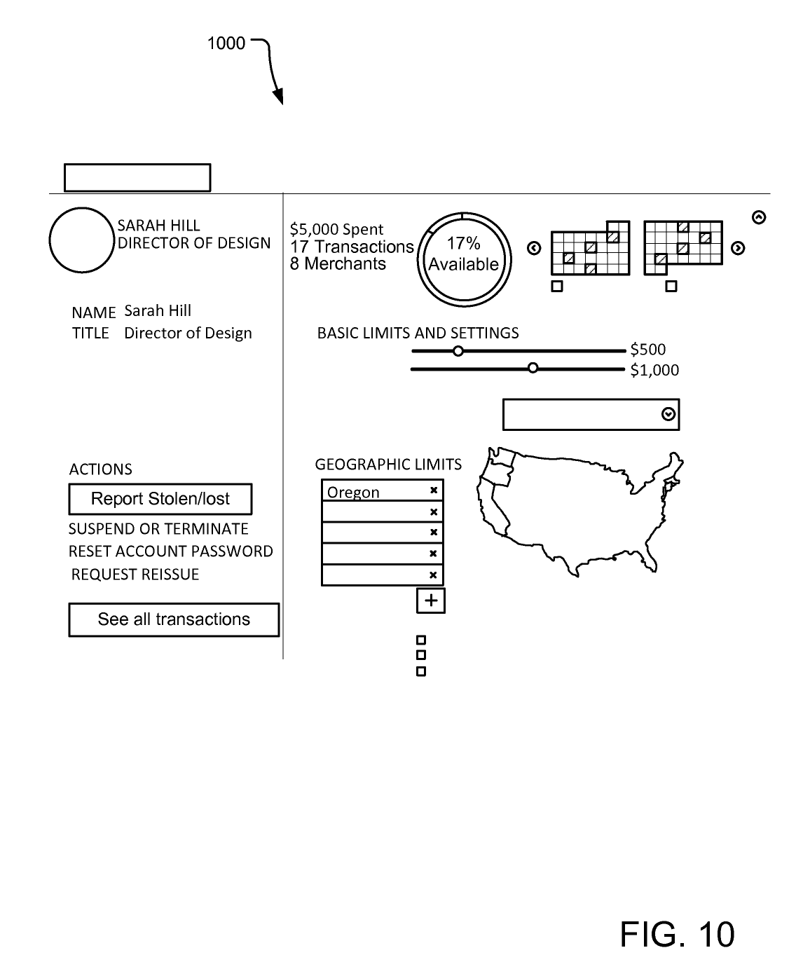

FIG. 10 illustrates an example graphical user interface 1000 displaying details for an individual cardholder's expense account. In the illustrated example, various expenses for a cardholder, Sarah Hill, are shown. Furthermore, the GUI 1000 also provides further details based on geographic spending, calendar based spending, etc. The GUI 1000 also allows the administrator or a user to report a stolen or lost card and to take a subsequent action, such as suspending the account, reissuing a card, etc.

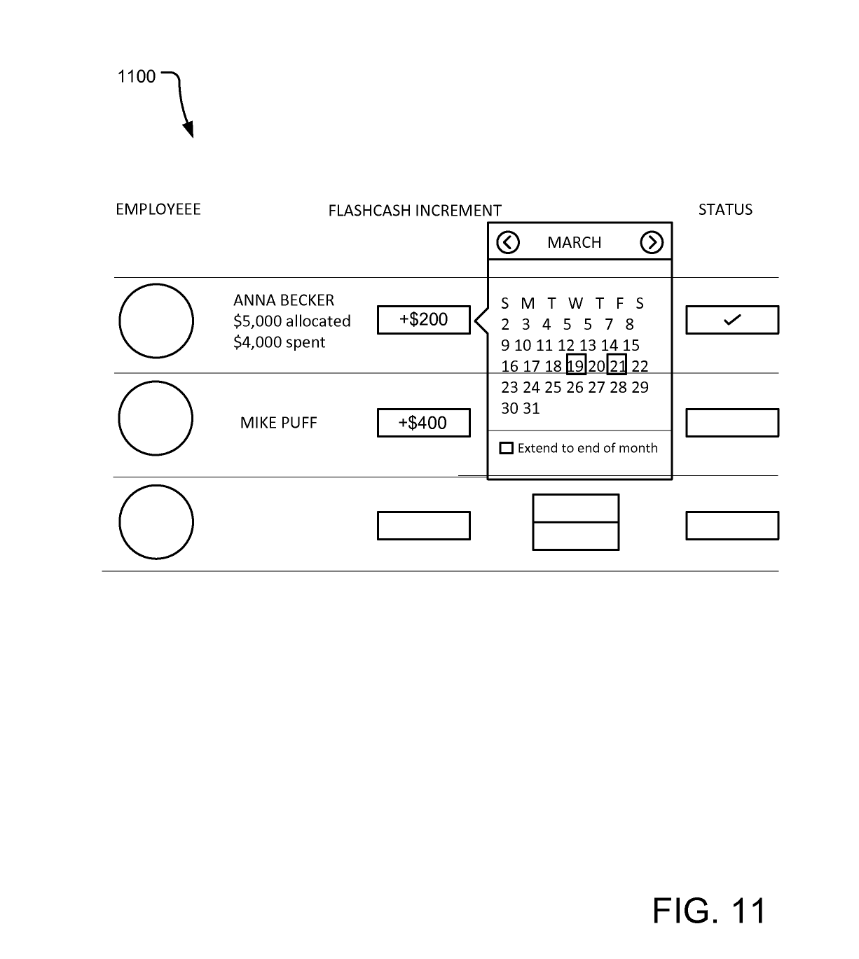

FIG. 11 illustrates an example graphical user interface 1100 that allows setting fund limits for a specific time period for a number of cardholders. In the illustrated example, the administrator is able to select the maximum monetary amount of transference from a funding account to the employee account within a specific period of time or cycle. For example, the administrator may have set the monthly expense limit for an employee Anna Becker for the month of March at $5,000. Using the GUI 1100, the administrator is able to find out the amount that Anna Becker has spent to date ($4,000) and increased the monthly expense limit by an additional amount. For example, in the given implementation, the Administrator increases the amount allocated by $200 so that the monthly total expense limit is increased to $5,200. Additionally, in an alternative implementation, the administrator may also attach a time limit within which such additional amount is to be spent for particular event, etc. For example, the additional expense of $200 may be tied to the time period between March 19 and 21. This may be to provide expenses to Anna for a specific event during this period. In such a case, the Administrator may also tie the additional fund to a geographic region using a mapping feature (not shown) or to a type of expense using a drop down list of various types of expenses (not shown). Yet alternatively, the administrator may extend the additional funds for the rest of the month so that Anna has $1,200 available for the rest of the month.

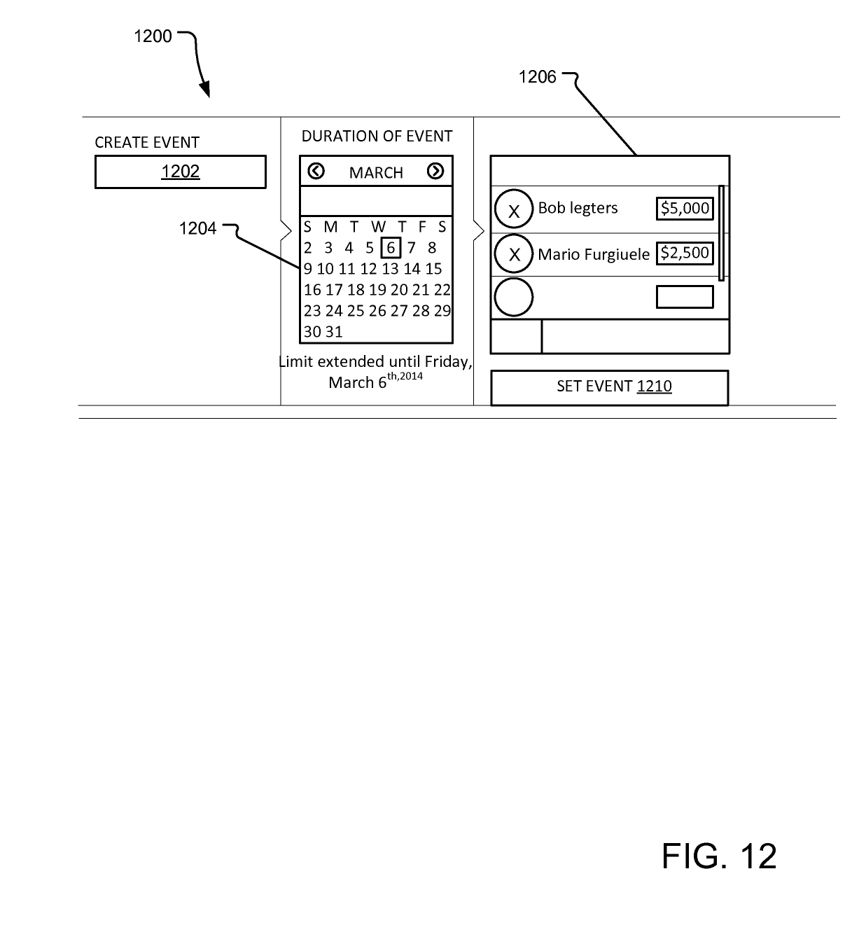

FIG. 12 illustrates an example graphical user interface 1200 that allows creating an event and setting fund limits for a number of cardholders related to the event. In the illustrated example, the administrator is able to create an event, which has a distinctive beginning time period by date and time and a distinctive end time period by date and time. For example, the administrator may initiate creating an event by selecting a UI control 1202, in response to which the administrator is presented a calendar UI element 1204 for setting the period for the event. The administrator can select a period by selecting two dates between which an event is created for providing additional funds. Alternatively, for an existing event, the administrator can select a date to end the event until when the event is extended. In the given example, the administrator extends an existing event until March 6 by moving the end of the event date to March 6.

Furthermore, the administrator is able to add cardholders of a particular population (groups or employees) along with corresponding card account values with the appropriate monetary limits. For example, the administrator can use a scrolling UI 1206 to select one or more cardholders that are associated with the event. In the illustrated example, the administrator selects cardholders Legters and Furgiuele to be added to the event. Furthermore, the administrator can add amount specific to the event that gets added to the monthly budget for the cardholder, for example, $5,000 for Mr. Legters. Once the parameters for the events are defined, the administrator can select the UI 1210 to set the event. Once the event is set, those assigned to the event will be able to transact using their payment instrument within the prescribed time period. Once an event is set, the payment system may contact a funding source to increase the total funds available for the organization by the amount of added funds or by a fraction of the added funds.

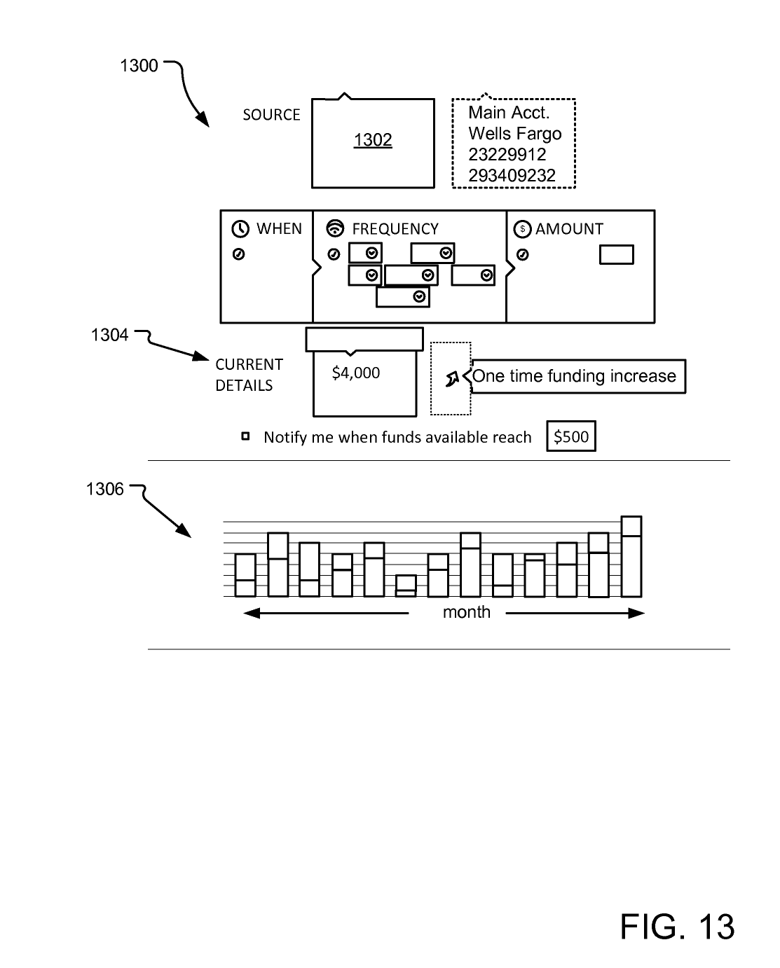

FIG. 13 illustrates an example graphical user interface 1300 that allows prediction of recurring transactions and related funding requirements related to a funding source 1302. The GUI 1300 also allows the administrator to add additional funding sources other than the main funding source disclosed therein. In the illustrated example, the administrator is able to view the date and time of spending (denoted as WHEN), the repetitive counts of transactions (denoted as FREQUENCY), the estimated expenditure of transactions (denoted as AMOUNT), the amount required to be transferred from the appropriate source of funds to the primary virtual account. In addition, the example denotes a minimum limit of $500 whereby the administrator is notified should the primary account fall below such limit. The GUI 1300 also allows the administrator to see the current details 1304 about the organizational account, such as the current balance of $4,000 available until next funding and the next funding date. A monthly overview display 1306 provides the administrator a view of the spent amount and the additional available amount for each of various months for a calendar year.

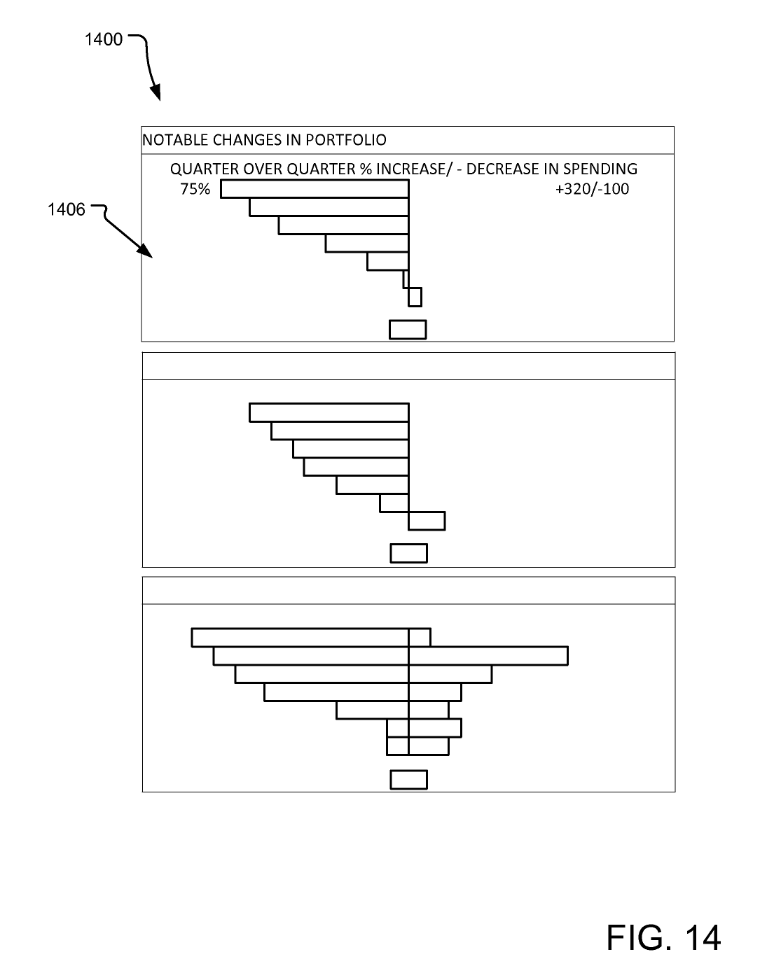

FIG. 14 illustrates an example graphical user interface 1400 that provides portfolio analytics and activity monitoring. In the illustrative example, the administrator is able to review the business entity spend by various dynamic data features inclusive of groups, cardholder, date and time of transactions and budgets. For example, the graph 1406 illustrates bars for percentage increase spending by the cardholders for various vendors, with the bars to the left indicating a decrease in the spending for a given quarter compared to a previous quarter and the bars to the right indicate increase in the spending.

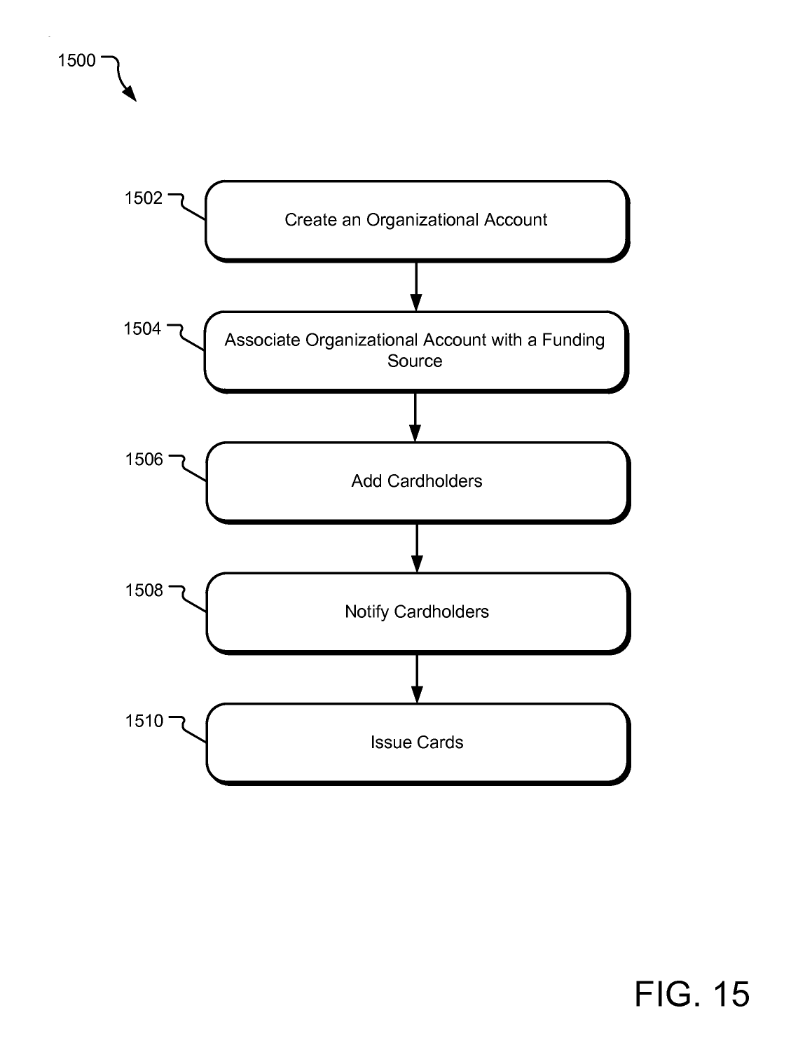

FIG. 15 illustrates a flowchart illustrating operations 1500 for setting up an organization on the payment system disclosed herein. An operation 1502 allows an administrator to set up an organizational account by providing various organizational information, such as the organization name, the employee identification number (EIN) for the organization, etc. In one implementation, the onboarding of the organization to the payment system includes requesting various incorporation documents of the organization from the administrator and verifying the incorporation documents before opening the organizational account. In one implementation, the administrator may scan and communicate the scanned documents to the payment system where the documents are reviewed to ascertain that accuracy of the organizational information. In an alternative implementation, an optical character recognition (OCR) method of other automated information review method may be used to verify the organizational information before creating the organizational account. Such verification of the organization information using the organization's incorporation documents allows the payment system to comply with various card-processing regulations. In yet alternative implementation, the payment system disclosed herein provides for a third party vendor to authenticate and/or verify the organization using the appropriate documents, such as articles of incorporation, etc. Furthermore, the payment system may also use third party, such as a credit provider, to approve the organization before creating the organizational account.

Subsequently, an operation 1504 associates the organizational account with a funding source. For example, a back account or multiple bank accounts may be associated with the organizational account. The bank accounts specified as the funding source provide funding for the transactions by the cardholders. Furthermore, the operation 1504 may also include providing funding rules for each of the funding source. For example, a funding rule may be to fund an account that is associated with the cards at a predetermined frequency with a predetermined amount. Another funding rule may be to fund such account anytime the balance falls below a predetermined amount.

An operation 1506 adds cardholders to the payment system. The cardholders may be the employees of the organization, one or more contractors of the organization, etc. Furthermore, each of the cardholders may also be associated with departments or groups within the organization. The operation 1506 also sets up periodic budgets may be set for various cardholders, departments, groups, and the organization. Subsequently an operation 1508 notifies the cardholders of their addition to the payment system. For example, the cardholders may be sent an email, a text message, and a message within a mobile device app, etc., to notify them of their addition to the payment system. For example, such a message sent to the cardholder may invite the cardholder to install an app on their device. Furthermore, the operation 1506 requires the cardholder to provide additional information about the cardholder, such as the cardholder's title in the organization, department, product group, etc. An operation 1510 uses the information collected from the cardholder to setup an account for the cardholder and issues a card. The issuance of the card may involve requesting a card number from a credit card processor, associating the card number with the organizational account, associating the card number with a department or group within the organization, etc.

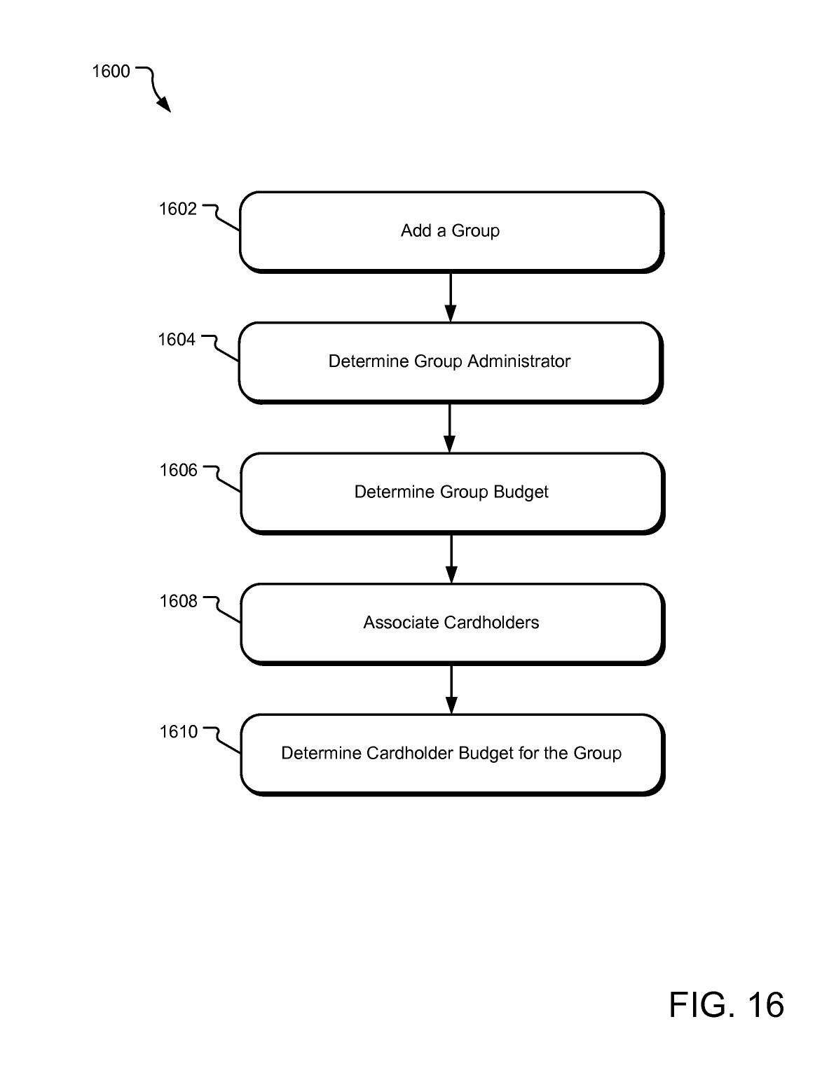

FIG. 16 illustrates a flowchart illustrating operations 1600 for creating groups within the organization, adding group members, and associating cardholders with groups. An operation 1602 adds a group to an organization. For example, various cardholders within the organization may be organized among various departments with each group including cardholders within a department, such marketing, sales, finance, etc. Alternatively, the cardholders may be organized in groups based on geographic regions, by product, by organizational objective, etc.

An operation 1604 may further assign group administrator for each of the groups created at operation 1602. In one implementation, the group administrators may be in charge of setting up cardholders for their group and setting up budget for the cardholders in their group. An operation 1606 determines and sets group budgets. Such budget may be monthly, weekly, quarterly, etc., with carryover, without carryover, etc. An operation 1608 associates the cardholders with the groups. An operation 1610 allocates the budgets for the cardholders based on group budgets.

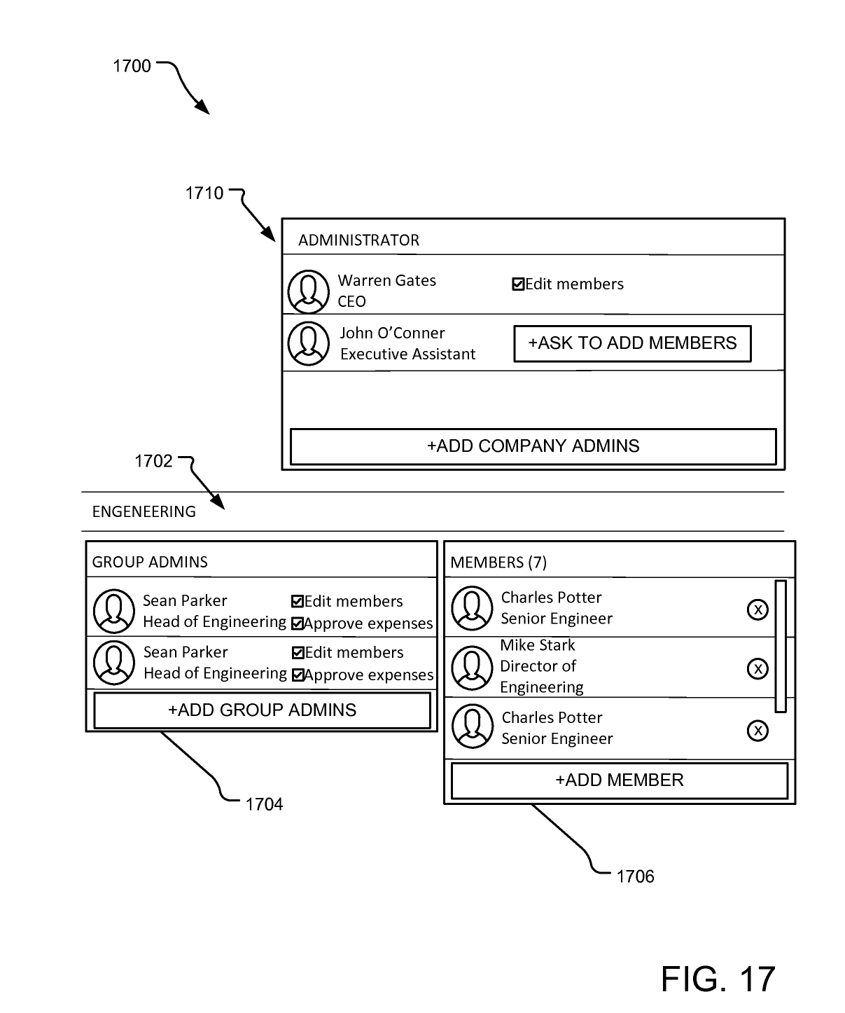

FIG. 17 illustrates an example graphical user interface 1700 that allows creating and managing groups within an organization using the payment system. Specifically, the GUI 1700 illustrates setting up the engineering group 1702 including setting up group administrators 1704 and associating members 1706 to the engineering group 1702. The organization administrator 1710 may select each of the cardholder from the members 1706 and review the cardholder budget for the selected member. Furthermore, when the administrator 1710 adds a cardholder using the “add member” option, a drop down list of all cardholders within the organization may be provided. Alternatively, in response to the “add member” an input box may be provided for inputting the name of the member to be added to the engineering group 1702.

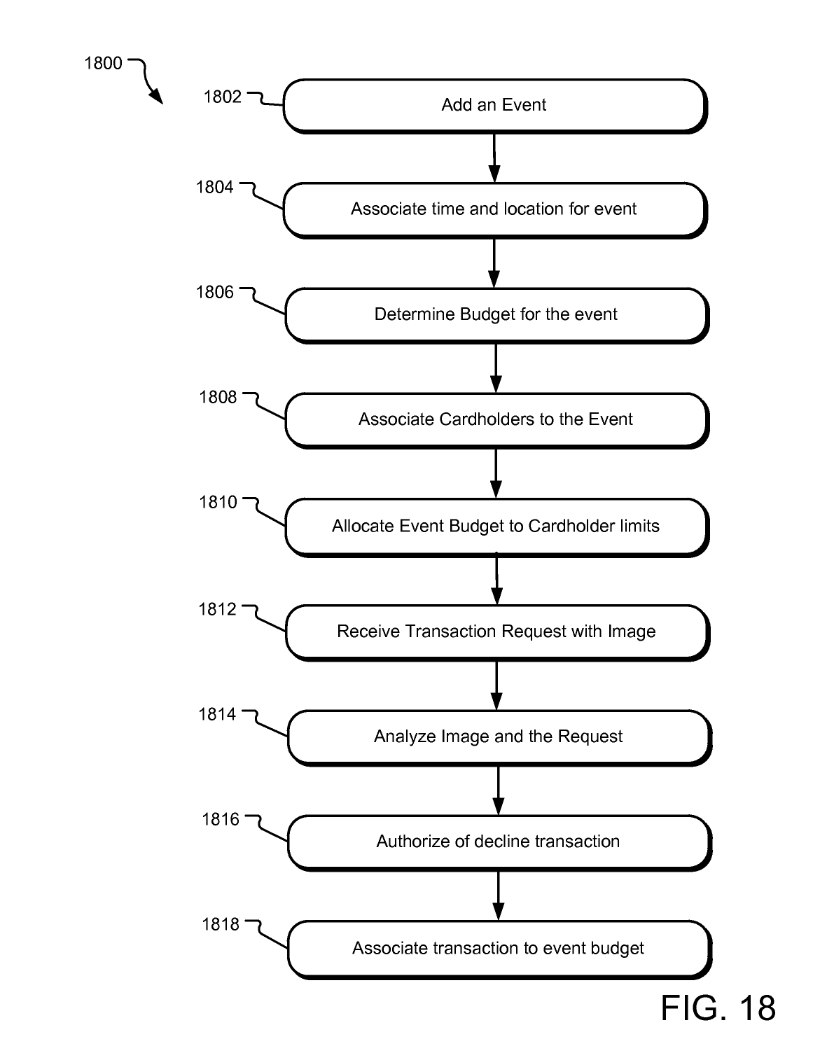

FIG. 18 illustrates a flowchart illustrating operations 1800 for creating events and setting funds for the event using the payment system. An operation 1802 adds an event to the payment system. Such event may be, for example, a meeting, a conference, etc., where one or more members of the organization may be participating. Alternatively, the event may be just an event such as a last day of an accounting period when the organization is expecting a high amount of activity by its cardholders and additional request for transactions. An operation 1804 associates the time and location of the event to the event. For example, if the event is a conference at Grand Hyatt hotel in Manhattan, N.Y., between September 25 and 27, the location of the hotel and the dates are associated with the event. Additionally, the operation 1804 may also indicate the acceptable range around the hotel that is associated with the event. In such a case, transactions occurring within this range are associated with the event. For example, such range may be within a radius of 1 mile around the hotel, the borough of Manhattan, the city of New York, etc.

An operation 1806 determines and associates a budget for the event. Associating of the budget for the event also adds the budget amount to the organizational budget for the organization for the period when the event is created. For example, if the organizational budget for the month of September is $50,000 and the event budget is $5,000, the organizational budget for the month of September is increased to $55,000. Such increase in the organizational budget may also require additional funding from a funding source to the account supporting the organization. Alternatively, such additional funding may be made just in time before the starting of the event on September 24^{th}.

An operation 1808 associates various cardholders to the budget. For example, if the event is related to launch of a product A, all cardholders in the product A group may be associated with the event. An operation 1810 allocates the event budget among all the cardholders that are associated with the event. Thus, in the example described above, if there are five cardholders that are associated with product A, the event budget of $5,000 is allocated among the five cardholders, either equally, based on other predetermined criterion, or at the discretion of the administrator of the organization or the group administrator. Allocating the event budget to the cardholders may result in generation of a message, an email, etc., to the cardholder. Furthermore, various budget reports are updated to account for such allocation of the event budget among the cardholders.

Subsequently, an operation 1812 may receive a request for a transaction from a cardholder where the transaction is related to the event. In one implementation, the payment system may be setup such that a request for a transaction related to an event requires an image of the product before the transaction is authorized. In such an implementation, upon request for an event related transaction, the payment system sends a message to the cardholder requesting an image. Such request for an image may be generated only if the transaction amount is above a predetermined threshold, if the transaction location is beyond a predetermined distance away from the event location, etc. Yet alternatively, the message for the image may automatically activate a camera or other image capturing apparatus of a mobile device of the cardholder or a point of sale system related to the transaction. Furthermore, the request for the image may be a request for a barcode or a QR code associated with the product, in which case, the payment system analyzes the barcode or the QR code to determine additional information about the product before approving the transaction.

An operation 1812 analyzes the image using image recognition technology to ascertain and identify the product. Based on the product identification, an operation 1816 either authorizes the transaction or declines the transaction. If the transaction is authorized, an operation 1818 associates the transaction to an event budget for the cardholder and the group that the cardholder is part of.

While the operations for requesting a product image and analyzing the product image are disclosed here in view of a transaction related to an event, in an alternative implementation, such operations may be provided for completion of other transactions as well. Yet alternatively, the image request may be generated in cases where a cardholder has a special request for an emergency transaction, etc. For example, if a cardholder has used up her allocated budget for a given period and if such cardholder requires an additional transaction for a product, in such a case, the payment system may require the cardholder to provide a product image before approving the transaction.

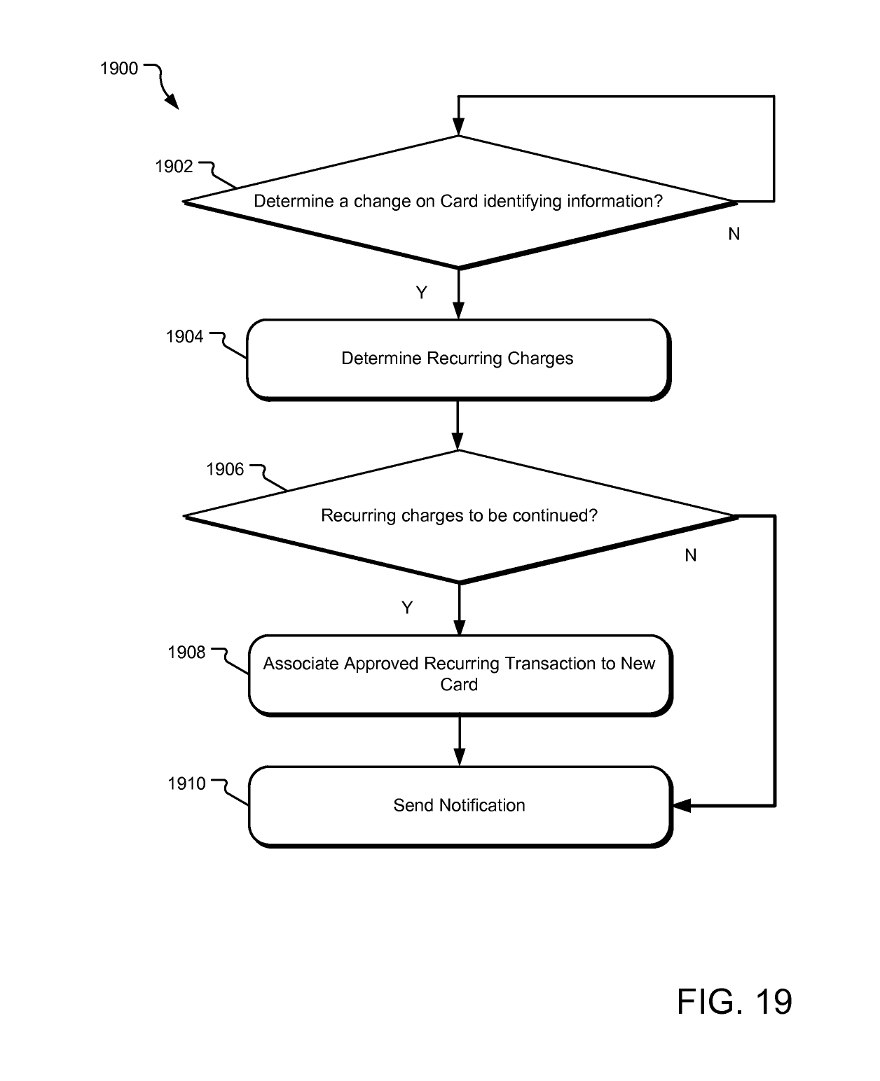

FIG. 19 illustrates a flowchart illustrating operations 1900 for determining usage of cards with changed numbers or expiration dates for recurring transactions. For example, if the security of a cardholder's card has been compromised, such cardholder may be provided a new card number. However, such change of card requires that the information about the new card is promulgated to vendors of existing recurring transactions. An operation 1902 determines such a change in card number or card identifying information, such as a change in expiration date of the card, etc. If such a change is determined, an operation 1904 determines all the recurring charges for such card. For example, such recurring charges may include monthly charge for a website maintenance, a monthly charge for a telephone number, etc.

An operation 1906 determines if one or more of such recurring charges are to be continued on the new card. If so, an operation 1908 associates the information about the new card to the recurring transaction. Otherwise, an operation 1910 sends a notification to the vendor of the recurring transaction about the termination of the existing card.

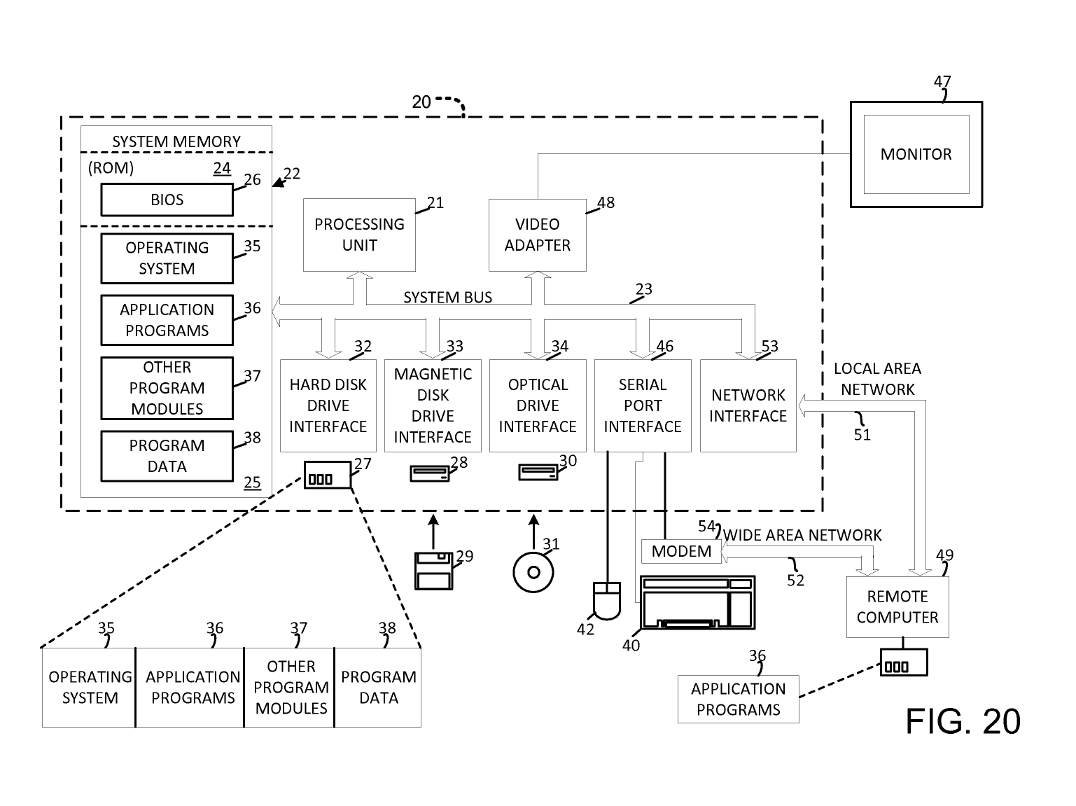

FIG. 20 illustrates an example system that may be useful in implementing the described technology. The example hardware and operating environment of FIG. 20 for implementing the described technology includes a computing device, such as general purpose computing device in the form of a gaming console or computer 20, a mobile telephone, a personal data assistant (PDA), a set top box, or other type of computing device. In the implementation of FIG. 20, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 20. The logical connections depicted in FIG. 20 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of and communications devices for establishing a communications link between the computers may be used.

In an example implementation, software or firmware instructions and data for providing a search management system, various applications, search context pipelines, search services, service, a local file index, a local or remote application content index, a provider API, a contextual application launcher, and other instructions and data may be stored in memory 22 and/or storage devices 29 or 31 and processed by the processing unit 21.

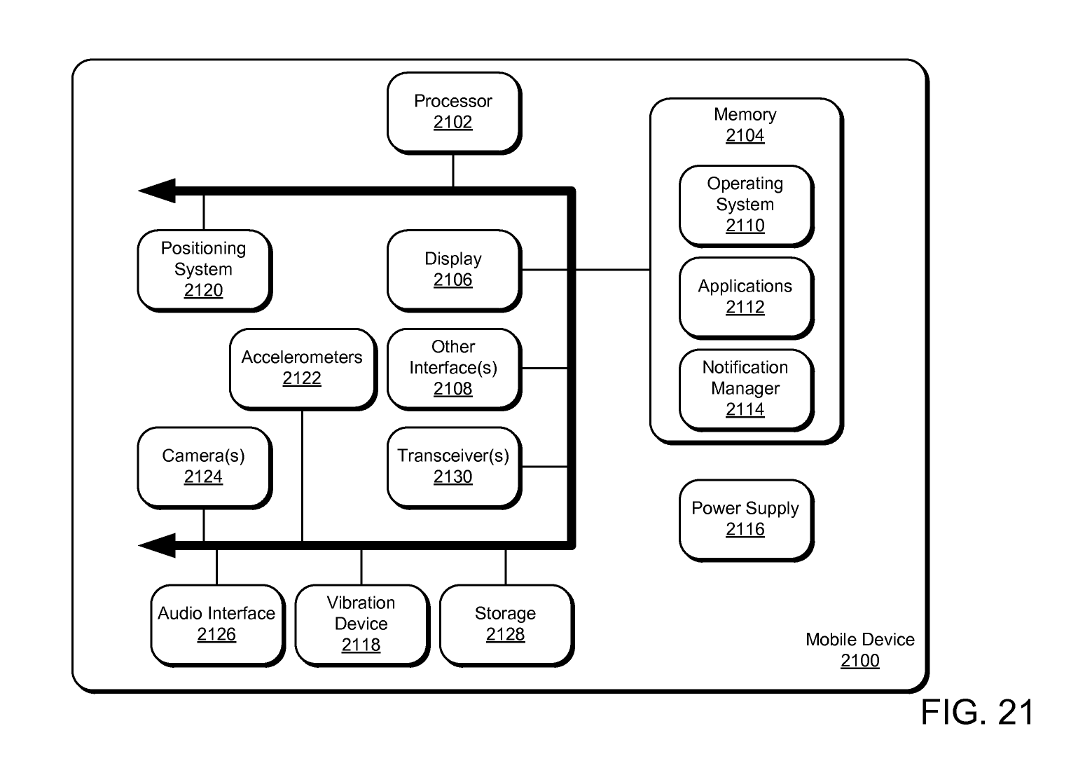

FIG. 21 illustrates another example system (labeled as a mobile device 2100) that may be useful in implementing the described payment system technology. The mobile device 2100 includes a processor 2102, a memory 2104, a display 2106 (e.g., a touchscreen display), and other interfaces 2108 (e.g., a keyboard). The memory 2104 generally includes both volatile memory (e.g., RAM) and non-volatile memory (e.g., flash memory). An operating system 2110, such as the Microsoft Windows® Phone 21 operating system, the Apple OS®, Android operating system, etc., resides in the memory 2104 and is executed by the processor 2102, although it should be understood that other operating systems may be employed.

One or more application programs 2112 are loaded in the memory 2104 and executed on the operating system 2110 by the processor 2102. Examples of applications 2112 include without limitation email programs, scheduling programs, personal information managers, Internet browsing programs, multimedia player applications, etc. An implementation of the mobile device 2100 may include a mobile payment application for the payment system disclosed herein, wherein the payment application communicates the payment system implemented on a cloud server. For example, such payment application may be configured to generate a GUI on the mobile device 2100 that provides interactive capabilities to a cardholder using various input modalities (touch, shake, etc.) provided by the mobile device. Furthermore, the payment application may also generate a QR code that can be scanned by merchants to complete payment transactions.

A notification manager 2114 is also loaded in the memory 2104 and is executed by the processor 2102 to present notifications to the user. For example, when a promotion is triggered and presented to the shopper, the notification manager 2114 can cause the mobile device 2100 to beep or vibrate (via the vibration device 2118) and display the promotion on the display 2106. The mobile device 2100 includes a power supply 2116, which is powered by one or more batteries or other power sources and which provides power to other components of the mobile device 2100. The power supply 2116 may also be connected to an external power source that overrides or recharges the built-in batteries or other power sources.

The mobile device 2100 includes one or more communication transceivers 2130 to provide network connectivity (e.g., mobile phone network, Wi-Fi®, BlueTooth®, etc.). The mobile device 2100 also includes various other components, such as a positioning system 2120 (e.g., a global positioning satellite transceiver), one or more accelerometers 2122, one or more cameras 2124, an audio interface 2126 (e.g., a microphone, an audio amplifier and speaker and/or audio jack), and additional storage 2128. Other configurations may also be employed.

In an example implementation, a web page optimization system, and other modules and services may be embodied by instructions stored in memory 2104 and/or storage devices 2128 and processed by the processing unit 2102. The master pages, the layouts, and other data may be stored in memory 2104 and/or storage devices 2128 as persistent datastores.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

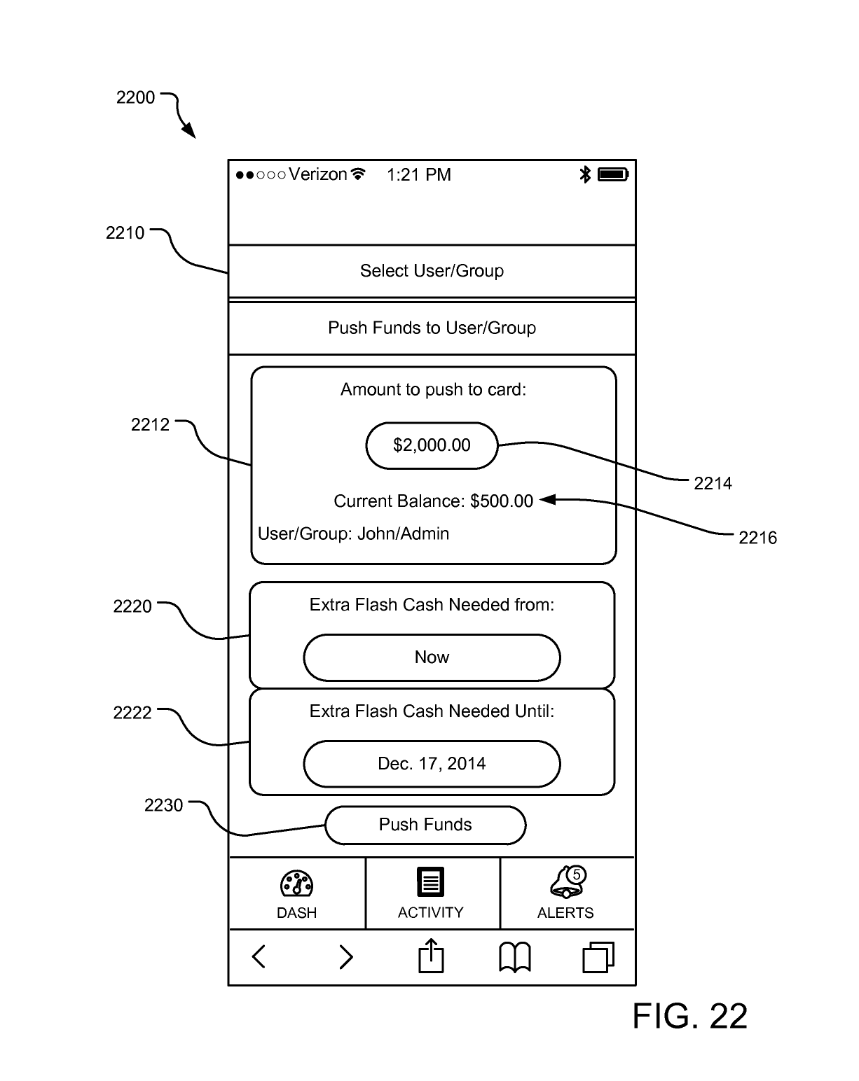

FIG. 22 illustrates an example graphical user interface 2200 that allows pushing time-based funds to a user. Specifically, the GUI 2200 may be used for pushing time-based funds available to individual users as well as to a group of users. The GUI 2200 may be accessed from one or more of the various other GUIs disclosed herein. An input window 2210 of the GUI 2200 allows an administrator to select a user of a group to which the time-based funds are pushed. Alternatively, when the GUI 2200 is accessed from another GUI that supplies the user/group information to the GUI 2200. The user may be any individual cardholder such as an employee, contractor, etc., of an organization. On the other hand, the group may be any department, product group, etc., having multiple member users that are cardholders. If a group is selected, in one implementation, a group leader, such as head of a department may be able to allocate the time-based funding to one or more cardholder members of the group.

The GUI 2200 also includes a window 2212 that may be used by the administrator to enter the amount of time-based funds at an input field 2214. The window 2212 also discloses the amount of current funds 2216 available to the user. Furthermore, the GUI 2200 also allows the administrator to provide the time period during which the time-based funds are available to user. For example, the administrator may use an input field 2220 to provide the starting date when the time-based funds are available and an input field 2222 to provide the ending date for the time-based funds. In one implementation, the default value of the starting date is the current date/time, as designated by “Now.” Once the administrator has selected one or more of the appropriate input fields 2214, 2220, 2222, etc., the administrator can select a button 2230 to push the funds to the user.

Upon the administrators pushing the funds, the user designated in the GUI 2220 receives communication indicating that additional time-based funds are available for a designated time period. Such communication may be in form of a text message, an email, an app based message, or combination of one or more of the above. Furthermore, appropriate budgets are also adjusted. For example, if the user was part of marketing department, the budget of the marketing department is also automatically updated to reflect the additional funds available to the user for the time period. In one implementation, the budget of each group may include a special line item to reflect the time-based funding for members of that group. Furthermore, appropriate processors are also notified of the time-based funds available to the user.

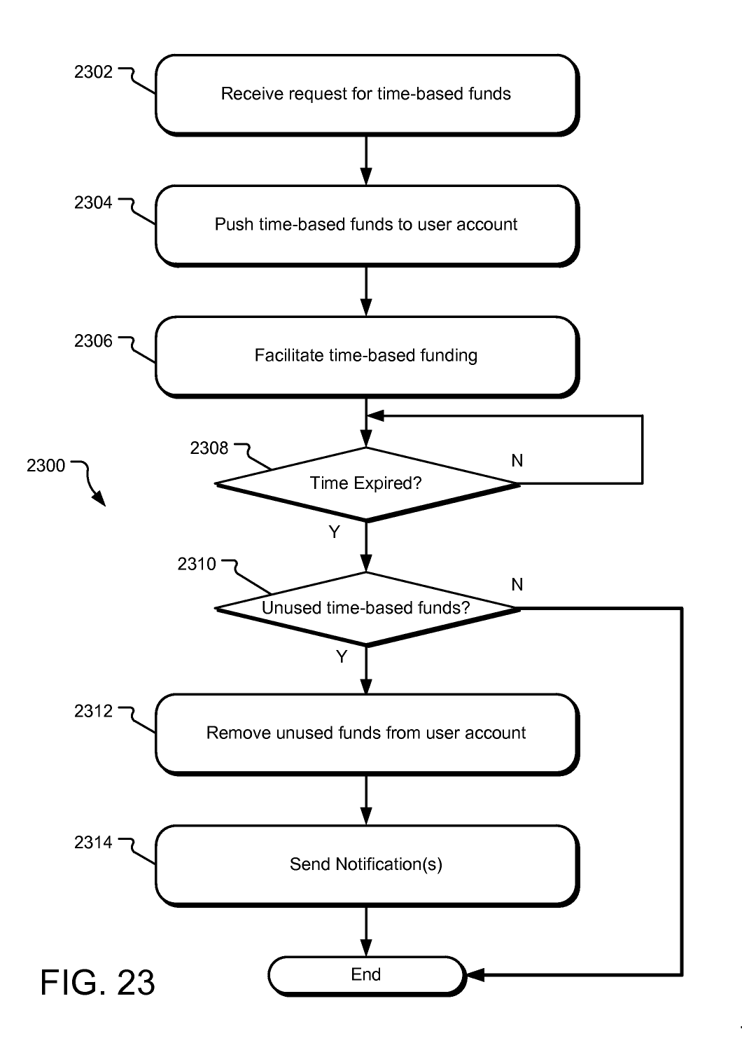

FIG. 23 illustrates a flowchart 2300 illustrating operations for providing and removing time-based funds available to a user. At operation 2302 an administrator receives a request from a user or from other source to provide time-based funds to a user or to a group. For example, a user may be attending a conference and may request additional funding towards the conference accommodation, etc. Upon receiving the request, an operation 2304 pushes time-based funds to the user. In one implementation, such pushing the time-based funds may be done by the administrator using a GUI that allows the administrator to enter the amount, the time period, etc.

In an alternative implementation, the operation 2304 may be set up to automatically analyze various information related to the user, the existing budgets, the requested amount, etc., to see if an automatic pushing of such time-based funding is appropriate. For example, the operation 2304 may use the seniority of the user, the total funds available to the user, the amount of requested time-based funds in comparison with a threshold amount, etc., to determine that the time-based funds may be automatically pushed to the user. In yet alternative implementation, the operation 2304 may automatically send a message to a department head before approving and pushing the time-based funds.

An operation 2306 sends appropriate communication to one or more processors, funding sources, etc., to facilitate allocation of the time-based funds to the for the time period. A determining operation 2308 triggers when the time period for the time-based funding has expired. At such expiration, an operation 2310 determined whether any funds are left from the user's time-based funds. For example, if the user is authorized $1,500 as time-based funds and if the user has used only $1,200, the operation 2310 may determine the leftover time-based funds to be $300.

In an implementation of the payment system, when a user is allocated a time-based funding, for every transaction that the user enters into during the time period, the user may be asked to identify whether the transaction is to be funded from the time-based funding for the user or from the general allocation to the user. Thus, suppose that a user is allocated a time-based funding of $1,000 during a time period of Jan. 1, 2015 to Jan. 5, 2015. In this case, if there is a recurring transaction on the user's account for a monthly fee for a periodical, such transaction may be funded from the general funds allocated to the user. However, if during the same period the user enters into a transaction for a lunch, the user may be asked to identify, either at the front end or later or, as to whether the lunch transaction is to be funded using the time-based funds.

In yet alternative implementation, when the user is allocated a time-based funding, the user may be required to provide various information identifying the purpose of the time based funding. For example, the user may be asked to provide the location where the time-based funds will be used, the type of transactions for the time-based funds, etc. In such a case, the information provided by the user may be used to determine whether a transaction is to be funded from the time-based funds or from the general funds available to the user.

If the operation 2310 determines that there are some unused time-based funds, an operation 2312 automatically removes such unused time-based funds from the user's account. Such removing the unused time-based funds may involve, for example, sending appropriate communication to one or more card-processors, funding sources, etc. Subsequently, an operation 2314 sends a notification to the user of the removal of such time-based funding.

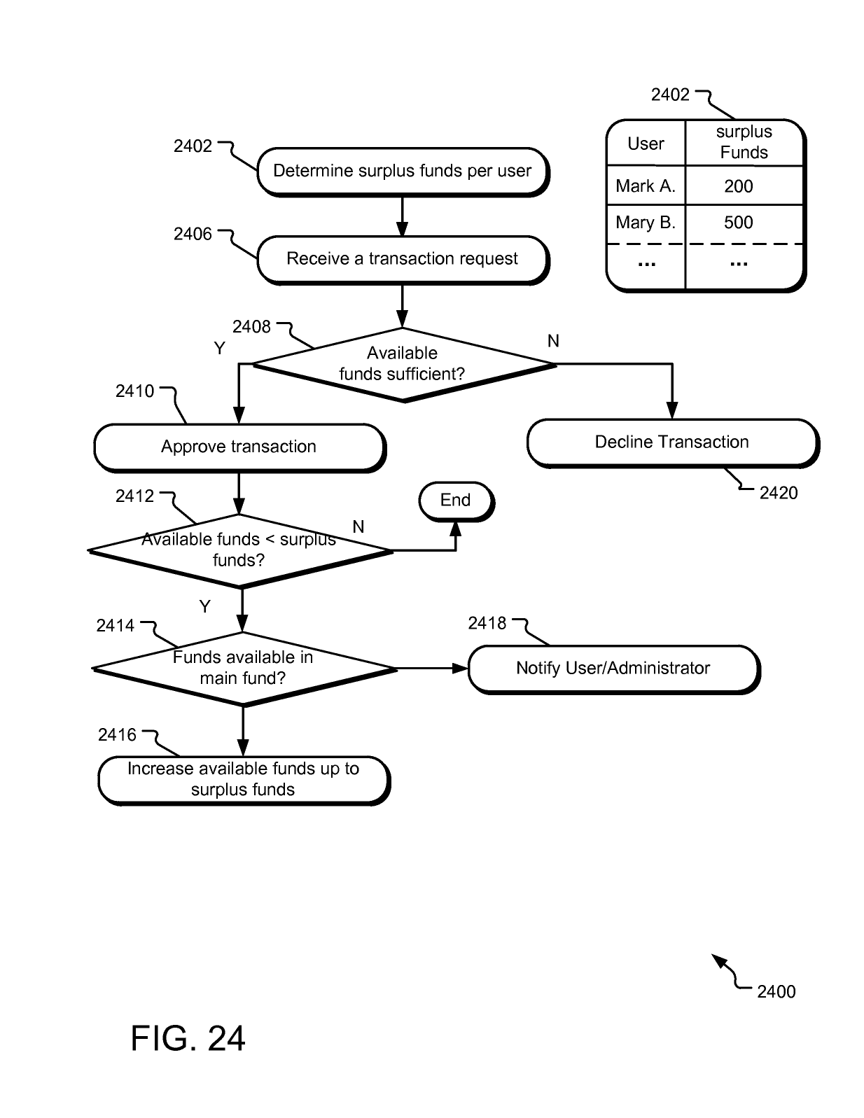

FIG. 24 illustrates a flowchart 2400 illustrating operations for ensuring that a predetermined amount of surplus funds are always available to a user. Specifically, the flowchart 2400 illustrates operations that may be implemented using a software system, a hardware system, a firmware system, or a combination thereof to ensure that the cards used by the various cardholders always have at least a predetermined amount of surplus funds available for transactions. This allows the cards to be used as debit cards for up to predetermined surplus amount. Specifically, the operations allows an administrator of the cards, such as an owner of a business, to set a surplus limit, such as $100, $200, etc., so that as long as the funding account has available balance, the cardholder always has the predetermined surplus amount of funds available for transactions. In this manner, the cardholder is not required to open an app to add money thereto or to periodically check the balance, with assurance that the card will cover transactions up to a certain surplus amount.

In an implementation, such predetermined surplus amount may vary per user. For example, FIG. 24 illustrates such varying surplus amounts per users where a user Mark A has $200 as surplus funds, a user Mary B has $500 as surplus funds, etc. An operation 2404 determines such surplus funds for each user, where such information may be stored in a centralized database, an app server, as well as in each individual user's app resident on their mobile device. An operation 2406 receives a transaction request, and in response to such a transaction request, an operation 2408 determines whether a card has sufficient funds available. For example, the operation 2406 may receive a request for a transaction in the amount of $150 from the user Mark A, where the user has $300 available as per his budgeted amount.

If the operation 2408 determines that the available funds ($300) are sufficient to cover the transaction amount ($150), an operation 2410 approves the transaction. Subsequently, an operation 2412 evaluates the revised amount of available funds to see if it is less than the surplus fund amount for Mark A. In the present case, the revised amount of available funds ($150) is less than the surplus amount for Mark A ($200). Therefore, an operation 2414 determines if the main fund for the organization have funds available to increase the available funds on the card for Mark A to his surplus. If so, an operation 2416 increases the funds available to Mark A (by $50) so that the available funds to Mark A is equivalent to the predetermined surplus amount ($200) for Mark A. If the operation 2414 determines that sufficient funds are not available in the main fund, an operation 2418 notifies the administrator and the user Mark A of the level of funds available to the user.

If the operation 2408 determines that the user does not have the funds available to fund the transaction control transfers to operation 2420. As an example, suppose that Mark A has only $175 available on his card when a transaction in the amount of $300 is requested. In that case, the operation 2420 declines the transaction.

Furthermore, the payment system disclosed herein is implemented as software as a service (SaaS) and it provides a number of application programming interfaces (APIs) for integration with third party applications or apps. A third party app may be able to communicate with and work with the payment system using one such API to provide additional services. As an example, an accounting application may be installed to work with the payment system using an API to receive transaction metadata and output accounting operations based on the transaction metadata. Other APIs of the payment system allows linking the payment system to one or more peer-to-peer lending networks that allows cardholders to gain access to funds and/or loans from such peer-to-peer lending networks. For example, a cardholder may be able to get funds made available on a card by tapping into such network. Alternatively, a cardholder may use funds available on the card, as permitted by the payment system, to lend funds to users of a lending network.

Similarly, an API of the payment system allows concierge networks to be connected with the payment system to allows cardholders to use the services provided by the concierge networks, such as booking flights, hotels, dinner reservations, etc. Furthermore, the API also allows the concierge service to coordinate event planning and funding for a cardholder or a department head. For example, if a department is planning a conference for a given time period in New York city, the department head can use the concierge service to plan the event, plan accommodation for the attendees, etc. Furthermore, the department head can also request specific event based funding based on the information generated by using the concierge network.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

Embodiments of the present technology are disclosed herein in the context of an electronic market system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it should be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions must be made in order to achieve the developer's specific goals, such as compliance with application- and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understand that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. (canceled)

2. (canceled)

3. (canceled)

4. (canceled)

5. (canceled)

6. A physical article of manufacture including one or more tangible computer-readable storage media encoding computer-executable instructions for executing on a computer system a computer process, the computer process comprising:
creating a fund account for an organization;
associating one or more funding sources to the fund account;
associating a plurality of debit cards to the fund account, each of the plurality of debit cards being associated with one of a plurality of members of the organization;
associating the plurality of debit cards with a group of members;
receiving a funding request to allocate a budgeted amount of funds to a predetermined group of the plurality of debit cards;
incrementally funding the fund account for the budgeted amount of funds from the funding source;
in response to the funding request, authorizing the predetermined group of the plurality of debit cards to expend up to the budgeted amount of funds over a predetermined period of time;
associating one or more of the plurality of members to an expense category and generating dynamic expense reports based on use of funds by the group of members associated with a given expense category.

7. (canceled)

8. The physical article of manufacture of claim 6, wherein the computer process further comprises setting limits on individual spending of the funds by one or more of the group of members.

9. The physical article of manufacture of claim 6, wherein the computer process further comprises:
receiving a request from a group administrator to increase the funds available to the group of members by an additional amount of funds;
approving the request to increase the funds;
in response to the request to increase the funds, sending a notification to the funding source to incrementally fund the fund account by the additional amount of funds from the funding source; and
sending a notification to the group administrator of the availability of the additional amount of funds.

10. The physical article of manufacture of claim 8, wherein the computer process further comprises:
presenting a user with an opportunity to create an event;
associating an event budget to the event;
associating one or more of the members of the group to the event; and
adjusting the funds available to the associated members of the group based on the event budget.

11. The physical article of manufacture of claim 10, wherein the computer process further comprises:
associating the event to a geographic location range and a time period range;
receiving a request for a transaction from the one or more of the members of the group;
allocating the transaction to the event budget if the location of the requested transaction is within the geographic location range and the time of the requested transaction is within the time period range.

12. The physical article of manufacture of claim 11, wherein if the location of the requested transaction is not within the geographic location range or the time of the requested transaction is not within the time period range, associating the requested transaction with the budgeted amount of funds not related to the event.

13. The physical article of manufacture of claim 10, wherein the computer process further comprising:
receiving a request from a cardholder for a transaction;
communicating a request for an image of a product related to the transaction to the cardholder;
automatically activating a camera of at least one of the cardholder's mobile device or a point of sale system related to the transaction;
communicating an image of the product related to the transaction to a server;
automatically analyzing the image to ascertain additional product related information; and
analyzing the product related information to approve the transaction.

14. The physical article of manufacture of claim 13, wherein the image associated with the product is at least one of a barcode and a QR code associated with the product.

15. The physical article of manufacture of claim 6, wherein creating a fund account for the organization further comprises:
receiving an organizational document identifying the corporate status of the organization;
automatically analyzing the organizational document using a document verification system; and
approving fund account creation based on output of the analysis.

16. One or more tangible computer-readable storage media storing computer executable instructions for performing a computer process on a computing system, the computer process comprising:
receiving a request from a first user for funds from an account related to an organization;
determining an organizational level of the user in the organization;
determining the fund access privilege of the first user based on the organizational level of the user;
associating a set of fund use privileges for the first user, the set of fund use privileges including an amount of funds available to the user, a type of transactions allowed using the funds and a time period for use of the funds;
receiving from a second user a request to increase the funds for the account by a second amount, wherein the request to increase the funds is received by a mobile device;
in response to the request, increasing the funds available to the first user by the second amount based on the fund use privileges;
receiving a request from a cardholder for a transaction,
communicating a request for an image of a product related to the transaction to the cardholder; and
automatically activating a camera of at least one of the cardholder's mobile device or a point of sale system related to the transaction.

17. The one or more tangible computer-readable storage media of claim 16, wherein the computer process further comprising generating the request to increase the funds by the second amount in response to receiving, from the second user, an input to create an organizational event.

18. The one or more tangible computer-readable storage media of claim 16, wherein the computer process further comprising associating an event budget to a group of members of the organization and associating the event budget to an event geographic range, an event time range, and an event product category.

19. The one or more tangible computer-readable storage media of claim 18, wherein the computer process further comprising receiving a transaction request from a group member and automatically associating the transaction request to the event budget if the location of the transaction is within the event geographic range, the time of the transaction is within the event time range, and the transaction is related to the event product category.

20. The one or more tangible computer-readable storage media of claim 18, wherein the computer process further comprising approving the transaction request if an amount of the transaction request is lower than a budget allocated to the event.
